(19) United States
(12) Patent Application Publication
(10) Pub. No.: US 2022/0150570 A1
(43) Pub. Date: May 12, 2022

(54) APPARATUS AND METHODS FOR DIGITAL LEDGER-BASED INTEGRATED INTERACTIVE DIGITAL TV APPLICATIONS

(71) Applicant: CHARTER COMMUNICATIONS OPERATING, LLC, St. Louis, MO (US)

(72) Inventors: SRILAL M. WEERASINGHE, St. Louis, MO (US); Matthew M. Fisher, St. Louis, MO (US); Vipul Patel, Duluth, GA (US)

(21) Appl. No.: 17/091,715

(22) Filed: Nov. 6, 2020

(51) Int. Cl. H04N 21/43; H04L 29/06; H04N 21/478

(52) U.S. Cl. CPC H04N 21/4307; H04L 65/80; H04N 21/47805; H04N 21/4781; H04L 65/601

(57) ABSTRACT

Apparatus and methods for providing a digital ledger-based interactive digital services over a network. In one embodiment, the exemplary apparatus and methods enable, via use of a computer program application (e.g., a synchronization mobile application), user interactivity with digital content and a secure private blockchain-based payment mode. Additional features include, among other, enhancements which enable user participation individually, or with other subscribers, in live or recorded content-based activities (such as e.g., wagering/trivia, voting/surveying, product selling, advertising promotion, auctioning, broadcasting, interactive commentary/gaming, exercising, etc.).

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

### 1. Technological Field

The present disclosure relates generally to the field of content delivery, and specifically in one exemplary aspect to an architecture which integrates or unifies content with computer program applications, via e.g., synchronization and a digital ledger-based architecture.

### 2. Description of Related Technology

The proliferation of the Internet and increased connection technologies such as broadband have contributed to the development of new media sources for information and entertainment. Accordingly, new and interesting opportunities for providing users with advanced features, applications and services have arisen; especially recently in the areas of both gaming and digital ledgers such as blockchain.

More specifically, the gaming industry has exploded with the consistent development of consoles made by, e.g., Sony, Microsoft, and Nintendo, as well as gaming applications which encourage massively multiplayer online (MMO) and interactive gaming, such as those by Twitch, Steam, and Activision Blizzard.

Concurrently, sports betting has become legalized in the U.S.; see the 2018 United States Supreme Court case, Murphy v. National Collegiate Athletic Association (NCAA), No. 16-476, 584 U.S. ______ (2018). This decision has wide implications for the gaming industry within the U.S.; in particular, online betting or wagering. Distributed ledger technology such as blockchain is expected to play a major role in such sports betting due to its anonymity feature, including in association with cryptocurrency-based payment methods. For instance, companies such as ZenSports have launched peer-to-peer betting products accompanied by their own payment tokens. Betting-related products have also recently begun to appear in association with network programming (e.g., television shows, live-events, etc.).

### Interactive Media Content

So-called “interactive TV” or “iTV” includes techniques for allowing viewers to interact with television content. In an iTV paradigm, various levels of interactivity may be provided. For example, low interactivity comprises current technologies for changing channels, increasing or reducing volume, and turning on or off the television content. Moderate interactivity may include services such as on-demand, pay-per-view, etc. where a user may search and select to view particular content, as well as so called “trick-mode” functionality (rewind, fast forward, pause, etc.). High interactivity may include, for example, providing an audience the ability to affect or interact with the television content. One exemplary embodiment of such high interactivity iTV includes real-time on-screen voting, in which audience votes create decisions that are reflected in how the program continues.

Enhanced TV (ETV) is one example of iTV. ETV is used primarily with respect to two-screen solutions (i.e., TV and PC services). In one embodiment, users of ETV services have a television and computer in the same room, and use the service to navigate their web browser to a particular program-specific website that is synchronized to the live program by the broadcast television network. In an alternative approach, the user's computer may have a television tuner card, or a television network or managed network (multiple systems operator (MSO)) may offer a web browser. However, instead of using a web browser to navigate to a particular program-specific website, many users, particularly the younger generation, are watching TV while engaging with mobile applications or “apps,” such as Facebook.

A mobile app is inherently interactive and a convenient mode for user interaction with the digital TV program. However, viewer participation on interactive digital applications—such as, e.g., (i) consumer surveys, (ii) polling and wagering on digital TV, (iii) product sales, and (iv) advertising/promoting—has not reached its full potential due to several factors including inter alia: (i) privacy, (iii) lack of trust, (ii) security, and (iv) technological barriers.

With respect to privacy, consumers are wary of sharing their information, especially in the wake of privacy regulations such as General Data Protection Regulation (GDPR) and California Consumer Privacy Act (CCPA). For example, with respect to selling products, consumers often shy away from product offers out of privacy concerns associated with divulging personal data.

Additionally, even when rewards are offered—e.g., sales gimmicks such as, “first 100 callers get an extra discount”—the veracity of seller claims are questionable/doubtful, as they are hard to prove, and law enforcement in this area is lax. The erosion of trust generally translates into lack of interest on the part of the consumer. Thus, consumers are not enthused about such offers due to the lack of a trustworthy reward mechanism.

Further, such product offers may be categorized as unwanted texts/emails and spam, which also turns users away from subscribing or downloading service-based digital applications. Even offers from viable or trustworthy sources may end up in a user's “junk” or spam folder, thereby causing the user to question the offer's veracity (e.g., as possible phishing).

Security concerns stem from, inter alia, the unsecure transaction framework used. Although a security failure may be technical in nature, the impact could be monetary, or loss or breach of confidential data.

Additionally, unlike the traditional managed service provider network (e.g., cable) model, IP-based digital media delivery enables receipt of individual streams. In a manifest manipulator-based architecture, the media content is broken into segments and stored in the content delivery network (CDN) origin server. The user client application downloads video segments from various different URLs per the manifest. Traditional cable networks have more monolithic architectures, and integrating new technologies such as blockchain is often a significant challenge. Even within native IP-based networks, there is no synchronizing mechanism to link a content stream with a mobile application.

Some blockchain-based advertisement prior art models include integration between an Internet browser and digital currency; however, such models do not take into account digital TV implications. For instance, Brave is a browser with a user rewarding mechanism. It employs tokens for this purpose (BAT—Basic Attention Token). The Brave browser model tracks user attention on web site/ads visited and rewards the user via tokens. Brave pays BAT coins to users for viewing ads. It is a linear model (a direct link between browser/viewer and the payee). The ads can be viewed anytime, but only passively and in a non-interactive fashion.

Further, such models may not provide for synchronization between multi-devices/screens which allows for enhanced user flexibility and avoids detraction from the content (e.g., movie or television program) viewing experience via menus or other on-screen display mechanisms.

Accordingly, improved apparatus and methods are needed to, inter alia, synchronize one or more digital media streams (e.g., one stream carrying network programming) to a digital application to enable client devices (e.g., TV, mobile device, etc.) to interact with the media carried on the one or more digital media streams. Such methods and apparatus should advantageously leverage blockchain- or other distributed ledger-based verification and/or transaction mechanisms to, inter alia, ensure privacy and security, especially with respect to user data and currency.

### SUMMARY

The present disclosure addresses the foregoing needs by providing, inter alia, methods and apparatus for generation of synchronized content within a content distribution network are disclosed.

In a first aspect, a computerized network server apparatus configured to provide synchronized content to one or more users of a content delivery network is disclosed. In one embodiment, the computerized network server apparatus includes: a storage entity; at least one network interface; and a digital processor apparatus in data communication with the storage entity and the at least one network interface, the digital processor apparatus configured to run at least one computer program thereon.

In one variant, the computer program includes a plurality of instructions which are configured to, when executed: receive, via a computer application executed on a computerized mobile device, data representative of a request to perform a synchronization operation; based on the request, perform the synchronization operation, the synchronization operation configured to identify synchronization data; and provide the synchronization data to the computerized mobile device, the synchronization data configured to enable the computerized mobile device to access the synchronized content via the computer application executed on the computerized mobile device.

In one implementation, the synchronization operation includes: transmission of data representative of a request for the synchronization data to a manifest manipulator (MM) apparatus, the data representative of the request for the synchronization data configured to cause the MM apparatus to (i) retrieve metadata relating to the digital content then-currently displayed on the computerized client device from an origin server apparatus, and (ii) process the metadata from the origin server apparatus to generate the synchronization data; and receipt of the synchronization data from the MM apparatus.

In another implementation, the plurality of instructions are further configured to, when executed: receive, via the computer application executed on the computerized mobile device, user input relating to the synchronized content; and transmit the user input relating to the synchronized content to a blockchain-based validation entity, the blockchain-based validation entity configured to validate the user input.

In another aspect, a method of providing enhanced user interactivity between computerized client devices is disclosed. In one embodiment, the method includes: causing delivery of first digital content via a first transport mechanism to a first computerized client device; receiving, from a second computerized client device, data representative of a request for second digital content, the second digital content relating to the first digital content; based on the data representative of the request for the second digital content, causing transmission of metadata to second computerized client device, the metadata configured to enable the second computerized client device to access the second digital content via second transport mechanism, wherein the second digital content is configured to prompt the second computerized client device for user input; and receiving data representative of the user input.

In a further aspect of the disclosure, a network architecture configured to enable both preservation of user privacy and validation of proposed rewards as part of interaction with third-party content delivered via the network architecture is described. In one embodiment the architecture includes: a first content delivery mechanism configured to deliver primary content to at least one user device of the network architecture; a second content delivery mechanism configured to deliver secondary content to the at least one user device of the network architecture; and server apparatus in data communication with the first content delivery mechanism and second content delivery mechanism, the server apparatus configured to utilize a private distributed ledger process to enable both (i) preservation of anonymity for an input provided by the user of the network architecture; and (ii) payment of a reward to an account of the user.

In one variant, the first content delivery mechanism comprises a downstream RF (radio frequency) channel in a first managed service provider network; and the second content delivery mechanism comprises a downstream RF (radio frequency) channel in a second managed service provider network.

In another variant, the server apparatus comprises a private blockchain process configured to at least (i) generate an anonymized user ID value associated with the at least one user device; and (ii) cause credit of the reward to a digital wallet account of the user.

In still another variant, the at least one user device comprises first and second user devices, the second user device comprising a mobile device with application computer program configured to execute thereon, the application computer program configured to communicate with the server apparatus for the (i) preservation of anonymity; and (ii) payment of a reward to an account of the user.

In another aspect, a computerized device capable of contributing to and controlling user interactivity enhancement or enrichment is disclosed and described. In one embodiment, the device comprises a personal or laptop computer. In another embodiment, the device comprises a mobile device (e.g., tablet or smartphone). In another embodiment, the device comprises a computerized “smart” television or gaming console.

In another aspect, a computer readable storage apparatus implementing one or more of the foregoing aspects is disclosed and described. In one embodiment, the computer readable apparatus comprises a program memory, or an EEPROM. In another embodiment, the apparatus includes a solid state drive (SSD) or other mass storage device. In another embodiment, the apparatus comprises a USB or other “flash drive” or other such portable removable storage device. In yet another embodiment, the apparatus comprises a “cloud” (network) based storage device which is remote from yet accessible via a computerized user or client electronic device.

In yet another aspect, a software architecture is disclosed. In one embodiment, the architecture includes an application layer process configured to run on a 5G capable UE, and which is accessible via e.g., MSO or external application overlay servers, and mobile devices of the user.

In another aspect, an integrated circuit (IC) device implementing one or more of the foregoing aspects is disclosed and described. In one embodiment, the IC device is embodied as a SoC (system on chip) device within a CPE or UE (mobile device). In another embodiment, an ASIC (application specific IC) is used as the basis of at least portions of the device. In yet another embodiment, a chip set (i.e., multiple ICs used in coordinated fashion) is disclosed. In yet another embodiment, the device includes a multi-logic block FPGA device.

These and other aspects shall become apparent when considered in light of the disclosure provided herein.

### BRIEF DESCRIPTION OF THE DRAWINGS

FIG. 1 is a functional block diagram illustrating an exemplary packetized content delivery network architecture useful with various aspects of the present disclosure.

FIG. 2 is a functional block diagram of a first exemplary embodiment of a content management and synchronization architecture in accordance with the present disclosure.

FIG. 2A is a functional block diagram of a second exemplary embodiment of a content management and synchronization architecture in accordance with the present disclosure.

FIG. 3 is a graphical representation of one exemplary implementation of operation of the architectures of FIGS. 2 and 2A, in accordance with the present disclosure.

FIG. 4 is a graphical representation of one exemplary implementation of a synchronization operation in accordance with the present disclosure.

FIG. 5 is a graphical representation of one exemplary implementation of mobile application interaction with blockchain-based apparatus, in accordance with the present disclosure.

FIG. 6 is a graphical representation of one exemplary implementation of integrating digital content and mobile applications, in accordance with the present disclosure.

FIG. 7 is a graphical representation of one exemplary implementation of an interconnected blockchain-based network, in accordance with the present disclosure.

FIG. 8 is a logical flow diagram illustrating an exemplary implementation of a method of syncronization and blockchain-based interaction, in accordance with the present disclosure.

FIG. 9 is a logical flow diagram illustrating one exemplary embodiment of a method for a synchronization operation, in accordance with the present disclosure.

FIG. 9A is a logical flow diagram illustrating one exemplary embodiment of a method for a synchronization operation of a synchronization server apparatus, in accordance with the present disclosure.

FIG. 10 is a ladder diagram illustrating an exemplary embodiment of a synchronization operation, in accordance with the present disclosure.

FIG. 11 is a logical flow diagram illustrating one exemplary embodiment of a method for a blockchain-based interaction operation, in accordance with the present disclosure.

FIG. 11A is a logical flow diagram illustrating one exemplary embodiment of a method for a blockchain-based interaction operation of a blockchain-based server apparatus, in accordance with the present disclosure.

FIG. 12 is a ladder diagram illustrating an exemplary embodiment of a blockchain-based interaction operation, in accordance with the present disclosure.

FIG. 13 is a functional block diagram illustrating an exemplary synchronization server configuration according to the present disclosure.

FIG. 14 is a functional block diagram illustrating an exemplary blockchain server configuration according to the present disclosure.

All figures © Copyright 2019-2020 Charter Communications Operating, LLC. All rights reserved.

### DETAILED DESCRIPTION

Reference is now made to the drawings wherein like numerals refer to like parts throughout.

As used herein, the term “application” (or “app”) refers generally and without limitation to a unit of executable software that implements a certain functionality or theme. The themes of applications vary broadly across any number of disciplines and functions (such as on-demand content management, e-commerce transactions, brokerage transactions, home entertainment, calculator etc.), and one application may have more than one theme. The unit of executable software generally runs in a predetermined environment; for example, the unit could include a downloadable Java Xlet™ that runs within the JavaTV™ environment.

As used herein, the terms “client device” or “user device” or “UE” include, but are not limited to, set-top boxes (e.g., DSTBs), gateways, modems, personal computers (PCs), and minicomputers, whether desktop, laptop, or otherwise, and mobile devices such as handheld computers, PDAs, personal media devices (PMDs), tablets, “phablets”, smartphones, and vehicle telematics or infotainment systems or portions thereof.

As used herein, the term “computer program” or “software” is meant to include any sequence or human or machine cognizable steps which perform a function. Such program may be rendered in virtually any programming language or environment including, for example, C/C++, Fortran, COBOL, PASCAL, assembly language, markup languages (e.g., HTML, SGML, XML, VoXML), and the like, as well as object-oriented environments such as the Common Object Request Broker Architecture (CORBA), Java™ (including J2ME, Java Beans, etc.) and the like.

As used herein, the term “DOC SIS” refers to any of the existing or planned variants of the Data Over Cable Services Interface Specification, including for example DOCSIS versions 1.0, 1.1, 2.0, 3.0, 3.1, 4.0, EuroDOCSIS, and Extended Spectrum (ES) DOCSIS.

As used herein, the term “headend” or “backend” refers generally to a networked system controlled by an operator (e.g., an MSO) that distributes programming to MSO clientele using client devices, or provides other services such as high-speed data delivery and backhaul.

As used herein, the terms “Internet” and “internet” are used interchangeably to refer to inter-networks including, without limitation, the Internet. Other common examples include but are not limited to: a network of external servers, “cloud” entities (such as memory or storage not local to a device, storage generally accessible at any time via a network connection, and the like), service nodes, access points, controller devices, client devices, etc.

As used herein, the term “LTE” refers to, without limitation and as applicable, any of the variants or Releases of the Long-Term Evolution wireless communication standard, including LTE-U (Long Term Evolution in unlicensed spectrum), LTE-LAA (Long Term Evolution, Licensed Assisted Access), LTE-A (LTE Advanced), 4G LTE, VoLTE (Voice over LTE), and other wireless data standards.

As used herein, the term “memory” includes any type of integrated circuit or other storage device adapted for storing digital data including, without limitation, ROM, PROM, EEPROM, DRAM, SDRAM, DDR/2 SDRAM, EDO/FPMS, RLDRAM, SRAM, “flash” memory (e.g., NAND/NOR), 3D memory, and PSRAM.

As used herein, the terms “microprocessor” and “processor” or “digital processor” are meant generally to include all types of digital processing devices including, without limitation, digital signal processors (DSPs), reduced instruction set computers (RISC), general-purpose (CISC) processors, microprocessors, gate arrays (e.g., FPGAs), PLDs, reconfigurable computer fabrics (RCFs), array processors, secure microprocessors, and application-specific integrated circuits (ASICs). Such digital processors may be contained on a single unitary IC die, or distributed across multiple components.

As used herein, the terms “MSO” or “multiple systems operator” refer to a cable, satellite, or terrestrial network provider having infrastructure required to deliver services including programming and data over those mediums.

As used herein, the terms “MNO” or “mobile network operator” refer to a cellular, satellite phone, WMAN (e.g., 802.16), or other network service provider having infrastructure required to deliver services including without limitation voice and data over those mediums. The term “MNO” as used herein is further intended to include MVNOs, MNVAs, and MVNEs.

As used herein, the terms “network” and “bearer network” refer generally to any type of telecommunications or data network including, without limitation, hybrid fiber coax (HFC) networks, satellite networks, telco networks, and data networks (including MANs, WANs, LANs, WLANs, internets, and intranets). Such networks or portions thereof may utilize any one or more different topologies (e.g., ring, bus, star, loop, etc.), transmission media (e.g., wired/RF cable, RF wireless, millimeter wave, optical, etc.) and/or communications technologies or networking protocols (e.g., SONET, DOCSIS, IEEE Std. 802.3, ATM, X.25, Frame Relay, 3GPP, 3GPP2, LTE/LTE-A/LTE-U/LTE-LAA, 5GNR, WAP, SIP, UDP, FTP, RTP/RTCP, H.323, etc.).

As used herein the terms “5G” and “New Radio (NR)” refer without limitation to apparatus, methods or systems compliant with 3GPP Release 15, 16 or 17, and any modifications, subsequent Releases, or amendments or supplements thereto which are directed to New Radio technology, whether licensed or unlicensed.

As used herein, the term “QAM” refers to modulation schemes used for sending signals over e.g., cable or other networks. Such modulation scheme might use any constellation level (e.g. QPSK, 16-QAM, 64-QAM, 256-QAM, etc.) depending on details of a network. A QAM may also refer to a physical channel modulated according to the schemes.

As used herein, the term “server” refers to any computerized component, system or entity regardless of form which is adapted to provide data, files, applications, content, or other services to one or more other devices or entities on a computer network.

As used herein, the term “storage” refers to without limitation computer hard drives, DVR device, memory, RAID devices or arrays, optical media (e.g., CD-ROMs, Laserdiscs, Blu-Ray, etc.), or any other devices or media capable of storing content or other information.

As used herein, “transmit” and “transmission” of data include without limitation transmitting packetized digital data, whether in wired or wireless fashion. Wireless transmission of data may be accomplished via various means, including via interfaces using IEEE Std. 802.11 (e.g., WLAN Wi-Fi) or 3GPP-based (e.g., 3G, 4G LTE, LTE-U, LTE-LAA, LTE-A, 4G/4.5G/5G) protocols. Such transmission allows a client device (e.g., smartphone, laptop, tablets) to download or stream the data from the transmitting entity.

As used herein the term “vMVPD” (“virtual-multichannel video programming distributor”) refers without limitation to an internetwork (e.g., Internet) based digital TV or service provider.

As used herein, the term “Wi-Fi” refers to, without limitation and as applicable, any of the variants of IEEE Std. 802.11 or related standards including 802.11 a/b/g/n/s/v/ac/ax/ay/ba, 802.11-2012/2013 or 802.11-2016, as well as Wi-Fi Direct (including inter alia, the “Wi-Fi Peer-to-Peer (P2P) Specification”, incorporated herein by reference in its entirety).

As used herein, the term “xNB” refers to any 3GPP-compliant node including without limitation eNBs (eUTRAN) and gNBs (5G NR).

### Overview

In one exemplary aspect, the present disclosure provides improved architectures, methods and apparatus that enable, via use of a computer program application (e.g., a synchronization mobile application), user interactivity with digital content, including a secure distributed ledger (e.g., blockchain) based payment mode. In one embodiment, active viewer participation and a ‘sync’ mechanism are leveraged. Specifically, three technologies are combined within a network architecture to provide the foregoing functionality; i.e., (i) digital content—e.g., episodes, game shows, movies, product sale, advertisements; (ii) distributed ledger technology such as blockchain—e.g., anonymous cryptographic user ID with digital wallet for transactions; and (iii) mobile applications—e.g., a mobile device and digital TV integration via a common user ID. User responses are submitted via the app.

In one implementation of the architecture, a manifest manipulator is used, wherein the media content is broken into segments and stored in a CDN origin server. The user client downloads video segments per the manifest for decode and rendering on a display device (such as a smart TV). A mobile application is used to enable user interaction with the content via a second screen, so as not to interfere with the primary viewing experience, and the host mobile device and the TV are integrated via common user-ID mapping. A private blockchain is used, and transaction records are encrypted with asynchronous keys (public/private) to ensure privacy and security, thereby providing both anonymity and verifiable payment of digital currency.

Additional features include, among others, enhancements which enable user participation individually, or with other subscribers, in live or recorded content-based activities (such as e.g., wagering/trivia, voting/surveying, product selling, advertising promotion, auctioning, broadcasting, interactive commentary/gaming, exercising, etc.).

### Detailed Description of Exemplary Embodiments

Exemplary embodiments of the apparatus and methods are now described in detail. While these exemplary embodiments are described in the context of the aforementioned hybrid fiber coax (HFC) cable system architecture having an multiple systems operator (MSO), digital networking capability, IP delivery capability, and plurality of client devices/CPE, the general principles and advantages of the present disclosure may be extended to other types of networks and architectures, whether broadband, narrowband, wired or wireless, managed or unmanaged, or otherwise, the following therefore being merely exemplary in nature.

It will also be appreciated that while described generally in the context of a consumer (e.g., home) end user domain, the present disclosure may be readily adapted to other types of environments (e.g., commercial/enterprise, government/military, etc.) as well. Myriad other applications are possible.

Also, while certain aspects are described primarily in the context of the well-known Internet Protocol, it will be appreciated that the present disclosure may utilize other types of protocols (and in fact bearer networks to include other internets and intranets) to implement the described functionality.

Other features and advantages of the present disclosure will immediately be recognized by persons of ordinary skill in the art with reference to the attached drawings and detailed description of exemplary embodiments as given below.

### Content Distribution Network

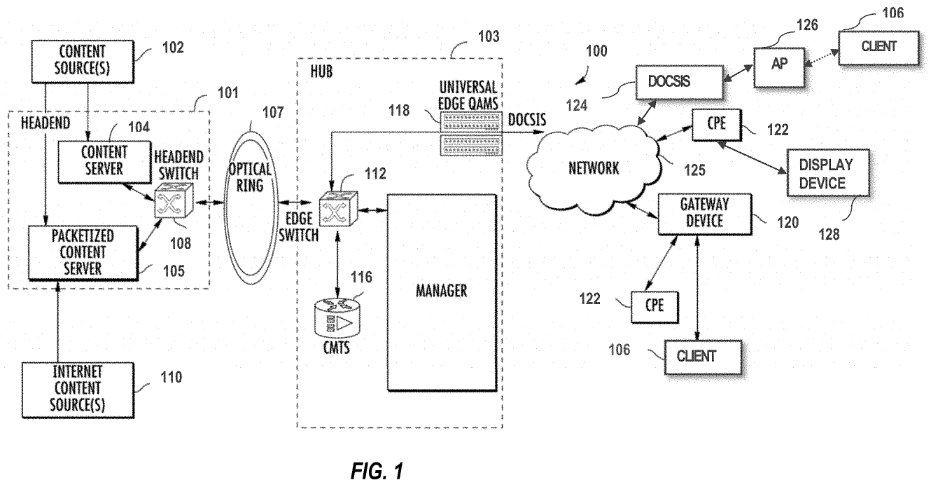

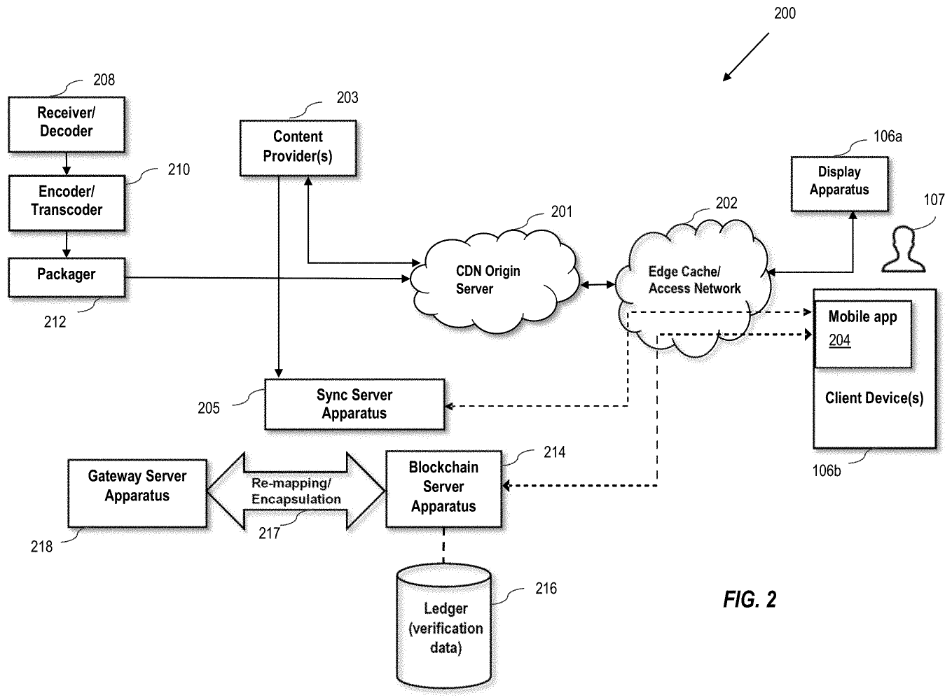

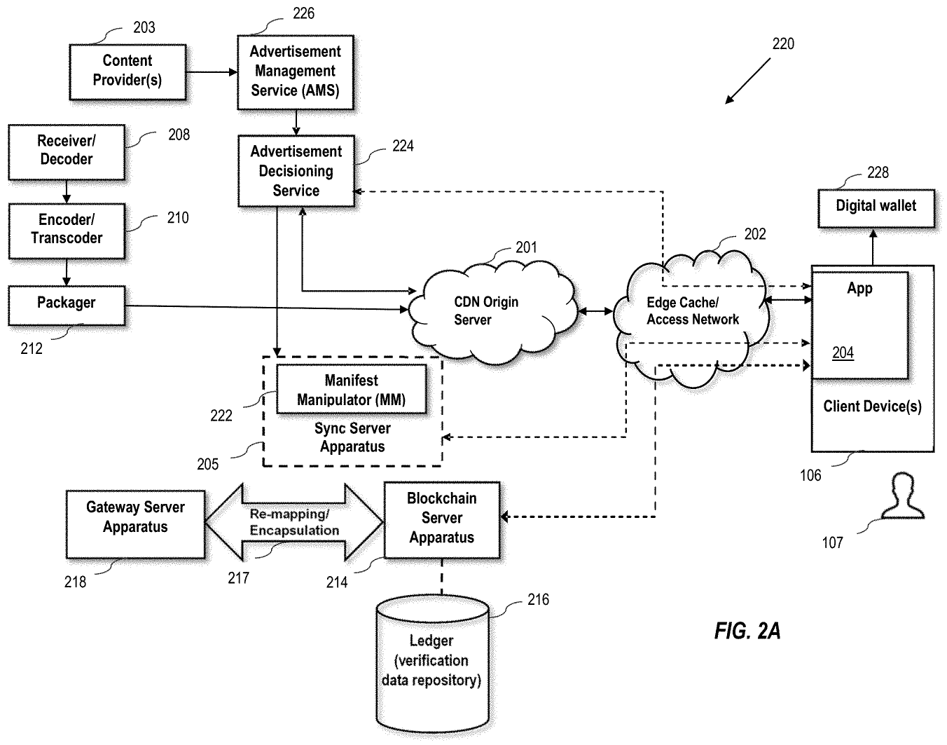

FIG. 1 illustrates a typical content distribution network architecture with which the exemplary content synchronization and interaction apparatus (see FIGS. 2-2A) and methods of the present disclosure may be used. The network architecture 100 of FIG. 1 is adapted for the delivery of packetized content (e.g., encoded digital content carried within a packet or frame structure or protocol), including IP packetized content. For instance, in addition to on-demand and broadcast content (e.g., video programming) normally delivered by such cable systems (e.g., using “in band” QAM channels), the system of FIG. 1 may deliver Internet data services and OTT (over-the-top) services using the Internet protocol (IP) and Transmission Control Protocol (TCP), although other protocols and transport mechanisms of the type well known in the digital communication art may be substituted.

The network architecture 100 generally comprises a local headend 101 in communication with at least one hub 103 via an optical ring 107. The distribution hub 103 is able to provide content to various user or client devices 106, CPE 122, and gateway devices 120, via a distribution network 125 such as one based on a hybrid fiber coaxial (HFC) infrastructure. User devices 106 such as 3GPP-compliant UE (e.g., smartphones or other mobile devices such as tablets or laptops, or even vehicle telematics systems) may be in direct communication with the AP 126 (whether MSO or MNO managed) as shown. For instance, in some configurations, the AP 126 may comprise a 3GPP based (e.g., 4G LTE or 5G NR) NodeB operating in a licensed, quasi-licensed (e.g., CBRS), or unlicensed band, including e.g., mmWave systems.

In this architecture 100, various content sources 102 are used to provide content to a content server 104. For example, content may be received from a local, regional, or network content library. Alternatively, content may be received from linear analog or digital feeds, as well as third party content sources. Internet content sources 110 (such as e.g., a web server) provide Internet content to a packetized content server 105. Other IP content may also be received at the packetized content server 105, such as voice over IP (VoIP) and/or IPTV content. Content may also be received from subscriber and non-subscriber devices (e.g., a PC or smartphone-originated user video). In one embodiment, the functionality of both the content server 104 and packetized content server 105 may be integrated into a single server entity.

A central media server located in the headend 101 may be used as an installed backup to the hub media servers as (i) the primary source for lower demand services, and (ii) as the source of the real time, centrally encoded programs with PVR (personal video recorder) capabilities. By distributing the servers to the hub stations 103 as shown in FIG. 1, the size of the fiber transport network associated with delivering VOD services from the central headend media server is advantageously reduced. Hence, each user has access to several server ports located on at least two servers. Multiple paths and channels are available for content and data distribution to each user, assuring high system reliability and enhanced asset availability. Substantial cost benefits are derived from the reduced need for a large content distribution network, and the reduced storage capacity requirements for hub servers (by virtue of the hub servers having to store and distribute less content).

It will also be recognized that a heterogeneous or mixed server approach may be utilized consistent with the disclosure. For example, one server configuration or architecture may be used for servicing cable, satellite, etc., subscriber CPE-based session requests (e.g., from a user's DSTB or the like), while a different configuration or architecture may be used for servicing mobile client requests. Similarly, the content servers 1004, 1006 may either be single-purpose/dedicated (e.g., where a given server is dedicated only to servicing certain types of requests), or alternatively multi-purpose (e.g., where a given server is capable of servicing requests from different sources).

The network architecture 100 of FIG. 1 may further include a legacy multiplexer/encrypter/modulator (MEM; not shown). In the present context, the content server 104 and packetized content server 105 may be coupled via a LAN to a headend switching device 108 such as an 802.3z Gigabit Ethernet (or “10G/10GbE”) device. For downstream delivery via the MSO infrastructure (i.e., QAMs), video and audio content is multiplexed at the headend 101 and transmitted to the edge switch device 112 (which may also comprise an 802.3z Gigabit Ethernet device) via the optical ring 107.

In one exemplary content delivery paradigm, MPEG-based video content (e.g., MPEG-2, H.264/AVC or H.265/HEVC) may be delivered to user IP-based client devices over the relevant physical transport (e.g., DOCSIS or other channels); that is as MPEG-over-IP-over-MPEG. Specifically, the higher layer MPEG or other encoded content may be encapsulated using an IP network-layer protocol, which then utilizes an MPEG packetization/container format of the type well known in the art for delivery over the RF channels or other transport, such as via a multiplexed transport stream (MPTS). In this fashion, a parallel delivery mode to the normal broadcast delivery exists; e.g., in the cable paradigm, delivery of video content both over traditional downstream QAMs to the tuner of the user's DSTB or other receiver device for viewing on the television, and also as packetized IP data over the DOCSIS QAMs to the user's PC or other IP-enabled device via the user's cable modem 124 (including to end users of the access node 126 (e.g., xNodeB or WLAN AP) and CPE 122). The CPE 122 may also provide connectivity for a WLAN router, as well as a connected display device such as a smart TV, gaming console or the like 1028 as shown. Delivery in such packetized modes may be unicast, multicast, or broadcast.

Delivery of the IP-encapsulated data may also occur over the non-DOCSIS QAMs, such as via IPTV or similar models with QoS applied.

Individual client devices such as cable modems 124 and associated end-user devices 122, 106 of the implementation of FIG. 1 may be configured to monitor the particular assigned RF channel (such as via a port or socket ID/address, or other such mechanism) for IP packets intended for the subscriber premises/address that they serve. The IP packets associated with Internet services are received by edge switch, and forwarded to the cable modem termination system (CMTS) 116. The CMTS examines the packets, and forwards packets intended for the local network to the edge switch. Other packets are in one variant discarded or routed to another component.

In a switched digital variant, the IP packets associated with Internet services are received by edge switch, and forwarded to the cable modem termination system (CMTS) 116. The CMTS examines the packets, and forwards packets intended for the local network to the edge switch. Other packets are in one variant discarded or routed to another component.

The edge switch forwards the packets receive from the CMTS to the QAM modulator, which transmits the packets on one or more physical (QAM-modulated RF) channels to the CPE. The IP packets are typically transmitted on RF channels that are different than the RF channels used for the broadcast video and audio programming, although this is not a requirement. As noted above, the CPE are each configured to monitor the particular assigned RF channel (such as via a port or socket ID/address, or other such mechanism) for IP packets intended for the subscriber premises/address that they serve.

In one embodiment, both IP data content and IP-packetized audio/video content is delivered to a user via one or more universal edge QAM devices 118. According to this embodiment, all of the content is delivered on DOCSIS channels, which are received by a premises gateway 120 (such as, e.g., service provider authorized gateways, which can be include blockchain-based functionality, described subsequently herein) and distributed to one or more CPE 122 in communication therewith. Alternatively, the CPE 122 may be configured to receive IP content directly without need of the gateway or other intermediary. As a complementary or back-up mechanism, audio/video content may also be provided in downstream (in-band) channels as discussed above; i.e., via traditional “video” in-band QAMs. In this fashion, a co-enabled digital set top box (DSTB) or other CPE could readily tune to the new (in-band) RF video QAM in the event that their IP session over the DOCSIS QAM is for some reason interrupted. This may even be accomplished via appropriate logic within the CPE (e.g., autonomously, or based on signaling received from the headend or other upstream entity, or even at direction of a user in the premises; e.g., by selecting an appropriate DSTB or other CPE function).

In the embodiment illustrated in FIG. 1, IP packetized content is provided to various user devices via the network 125. For example, content may be delivered to a gateway apparatus 120 which distributes content received thereat to one or more CPE 122 in communication with the apparatus 120.

In another variant, IP simulcast content and existing on-demand, voice, and broadcast content are all provided to the headend switch device 108 of FIG. 1. The headend switch 108 then provides the content to the optical ring 107 for provision to one or more distribution hubs 103. IP simulcast content is in one exemplary implementation retrieved from a plurality of content sources at an IPTV server.

The IP-packet content is transmitted to subscriber devices via the universal edge QAM 118 and the edge network 125. The IP video (“simulcast”) content is presented to client devices capable of receiving content over the DOCSIS QAMs. For example, the aforementioned gateway device 120 (as well as an advanced CPE 122 such as an IP-enabled DSTB) may receive the IP simulcast. Legacy CPE may receive content via the gateway device 120, or via an audio/video “back-up” MPEG transport stream as previously described.

In the illustrated embodiment, the gateway device 120 serves as a gateway to the IP content for other client devices (such as other CPE 122 and user devices 106). The gateway device 120 may communicate with one or more connected CPE 122, as well as utilize Wi-Fi capabilities (where so equipped) to communicate wirelessly to other devices. It will also be recognized that the present disclosure may be configured with one or more short-range wireless links such as Bluetooth (e.g., BLE) for lower bandwidth applications (or UWB/PAN for greater bandwidth applications). The gateway may also comprises a 5G mmWave or similar wireless modem, such as in the form of small cell for use within a given premises.

In another embodiment (not shown), the headend of the architecture 100 may use a so-called modular headend architecture or MHA. As a brief aside, the MHA (see e.g. CableLabs Technical Report CM-TR-MHA-V02-081209, which is incorporated herein by reference in its entirety) essentially separates the downstream PHY layer out of the CMTS, and move it to a separate EQAM device. In this architecture, the CMTS transmits data to the EQAM via the Downstream External PHY Interface (DEPT). This architecture was introduced in order to reuse EQAM to modulate both the data bits as MPEG video bits. The upstream receiver is kept in the CMTS in the MHA.

In contrast, another architecture used in implementing headend platforms is the Converged Cable Access Platform (CCAP). In order to increase efficiency, the CCAP integrates the EQAM and CMTS into one platform. In addition, in the CCAP, all the downstream traffic, including DOCSIS and video QAMs are transmitted in a single port. The CCAP unifies the CMTS, switching, routing, and QAM modulator in one unit, so that all data and video are converted in IP packets before conversion to RF signals.

The Remote PHY technology, also known as Modular Headend Architecture Version 2 (MHAV2), removes the PHY from the CMTS/CCAP platform and places it in a separate access point that is interconnected with an IP network. One common location to place the remote PHY is the optical node that is located at the junction of the fiber and coax cable networks.

In the MHAV2 architecture, the CCAP includes two separate components, CCAP core and the Remote PHY Device (RPD). The CCAP core contains a CMTS core for DOCSIS, and an EQAM core for video. The CMTS core contains the DOCSIS MAC, upper layer DOCSIS protocols, all signaling functions, downstream and upstream scheduling. The EQAM core processes all the video processing. Similarly, an RMD (generally analogous to the RPD, but containing the DOCSIS MAC, also colloquially referred to a s a “Flex MAC”) is also specified; see e.g., CableLabs Technical Report CM-TR-R-MACPHY-V01-150730, which is incorporated herein by reference in its entirety.

The RPD/RMD processes all the PHY related function, such as downstream QAM modulators, upstream QAM demodulators, upstream coders, downstream decoders, filtering, time and frequency synchronization, as well as the logic to connect to the CCAP core. One motivation for using such approaches as RPD/RMD is the ability to obviate analog fiber components between the headend and optical nodes, and rather utilize digital optical PHY and interfaces thereby enhancing quality at the nodes.

Hence, it will be appreciated by one of ordinary skill given the present disclosure that the exemplary network architectures described below with respect to FIGS. 2 and 2A may be readily adapted to any of the foregoing models or paradigms (e.g., MHA, MHAv2, etc.), and yet other configurations are possible, those of FIGS. 2-2A being merely non-limiting examples.

### Exemplary Content Management and Synchronization Infrastructure

FIG. 2 is a block diagram of an exemplary embodiment of a network architecture 200 configured to implement the various aspects of the disclosure. It will be appreciated that the architecture 200 of FIG. 2 can be used in conjunction with the foregoing network content distribution architecture 100 of FIG. 1 discussed supra, or can form the basis of its own distribution and delivery architecture. For instance, the architectures and systems discussed in co-owned U.S. patent application Ser. No. 13/403,802 filed on Feb. 23, 2012 and entitled “APPARATUS AND METHODS FOR PROVIDING CONTENT TO AN IP-ENABLED DEVICE IN A CONTENT DISTRIBUTION NETWORK”, published as U.S. Patent Pub, No. 20130227283, which is incorporated herein by reference in its entirety, may be utilized in conjunction with the present disclosure as well.

As shown in FIG. 2, the exemplary management and synchronization infrastructure 200 generally includes a receiver/decoder entity 208, which receives content (e.g., audio, video, data, files, etc.). The content is then encoded at the encoder/transcoder 210 to an appropriate format (codec, bitrate, etc.) for the requesting device 106. In one implementation, video is transcoded from a mezzanine quality down to e.g., MPEG-4 i.e., from lossless to lossy encoding. The encoder/transcoder 210 may also be used to transcode the content to MP4 in MPEG-2 transport stream (TS) format in a non-rate adaptive manner. The non-rate adaptive format may be used in this case because the stream has a constant bit rate (CBR) at this stage. Utilization of the MPEG-2 TS container enables the MP4 or other content to be multicast to a plurality of devices on the network. Additionally, the MPEG-2 TS content may be delivered with advertisement or other “secondary” content inserted therein via one or more intermediary advertisement insertion mechanisms (not shown).

The encoded content is passed from the encoder 210 to the packager 212, where various service variants are generated and distributed to an origin server 201. The service variants created by the packager 212 correspond to the various services identified by the content providers 201. Thus, each service variant is, in the illustrated embodiment, provided a different playlist (or manifest) containing one or more triggers or markers for varying content based on various considerations. In addition, certain service variants may have triggers embedded in the manifest which other variants may not have.

When primary content is requested by the client 106, the request is serviced via the edge cache 202 which receives content from the origin server 201. Primary content may be stored at the edge 202 in order to facilitate delivery thereof with less latency than content delivered from the origin server 201 (or even deeper towards the core of the network). A content request from a client device 106a, 106b to the edge cache 202 in one implementation contains at least the headend ID (or other identifier) assigned to the client device by an authorization server (not shown). Alternatively, the MAC address or other device/user-specific identifier (e.g., IP address) or URL which is associated with a known or determinable location may be utilized. Yet further, location-specific coordinates such as e.g., GPS/A-GPS—generated lat./lon., zip code, or other geolocation data may be used to identify one or more such locations. The edge cache 202 uses the identifier in one configuration to ensure that the appropriate service variant is provided to the requesting device 106.

In one implementation, processing can be substantially provided on the backend to enable a “thinner” client device (i.e., one with less processing capabilities). For example, the synchronization (“sync”) server 205 can retrieve the URL or program ID for the network programming and correlate it to information regarding which supplemental content (e.g., trivia questions) should be synced to the primary content. Further, the sync server 205 may consult a list of pre-designated supplemental content provided by the content provider(s) to determine which URL (i.e., the URL for which content) should be transmitted to the requesting device 106a, 106b.

In another implementation, the client device 106b can be responsible for most of the processing. For example, the sync server 205 can retrieve the URL or program ID for the network programming and transmit it to the requesting device. The app 204 operative on e.g., the mobile device 106b can then utilize the program ID for the primary content being displayed on the display device 106a to retrieve corresponding (supplemental) content (e.g., a trivia question).

In one exemplary embodiment, the aforementioned app is an MSO or third party “app” (application program) 204 operative to run on the client(s) 106 which is configured to interface with the MSO's IP-packetized content delivery service. That is, the mobile app 204 can provide a single unified interface for interaction with content delivered by the network.

In one exemplary implementation, during playback of the primary content according to the playlist or manifest thereof—e.g., the user 107 is watching a program (program #123) and, e.g., a trivia question is displayed on a portion of the screen—the user 107 may select a “sync” button or function on the app 204. Based on the “sync” function selection, the device 106b contacts the sync server 205. For instance, in one exemplary configuration, the device 106b contacts the sync server 205 using a RESTful (Representation State Transfer) protocol to enable retrieving the location data. RESTful services or interfaces allow requesting systems to access and manipulate prescribed representations of “resources” (e.g., data, files, URLs, etc.) using a predefined set of stateless operations. Hence, the use of a RESTful interface in the exemplary embodiment of FIG. 2 advantageously simplifies the maintenance and operation of the interface between the client 106b and the sync server 205, in that no state information need be maintained to support this GET operation. The sync server 205 can simply use the GET request at any time to obtain the desired location data from the device 106 in order to present the user 107 with “synced content” via the display 106a.

Also includes in the infrastructure 200 of FIG. 2 are a (private) blockchain server 214, associated ledger (verification database) 216, as well a gateway server 218 and remapping and encapsulation function 217. These components coordinate, as described in greater detail below, to provide inter alia, security and related functions for the user device/app 204 during content interactivity and synchronization.

Referring now to FIG. 2A, a second embodiment of content management and synchronization infrastructure 220 in accordance with the present disclosure is shown. The exemplary infrastructure 220 generally comprises an Advertisement Management Service (AMS) 226, which is configured to select individual ones of a plurality of secondary content (e.g., advertisements, promotions or “info-mercials”, commercials, telescoping information/advertisements, and short segments) for delivery to individual ones of the client devices 106 from an secondary content store (not shown). The AMS 226 may, in one embodiment, comprise a server or other computerized device and may be adapted to comply with the requirements set forth in the Society of Cable Telecommunications Engineers SCTE 130-1 and SCTE 130-3 Digital Program Insertion—Advertising Systems Interfaces standards, and/or IAB (Interactive Advertising Bureau) standards and practices, including e.g., those set forth in “Traffic Fraud: Best Practices for Reducing Risk to Exposure”, updated May 2015; “OpenRTB Dynamic Native Ads API—Specification Version 1” dated February 2015; “OpenDirect API Specification Version 1.0”, finalized January 2015; “Digital Video In-Stream Ad Format Guidelines” released Jan. 8, 2016; “RTB Project OpenRTB API Specification Version 2.4” (Final Draft) dated March 2016; and “RTB Project OpenRTB Dynamic Native Ads API, Specification Version 1.1” dated March 2016, each of the foregoing incorporated herein by reference in its entirety.

In one embodiment, the AMS 226 is in communication with an Advertisement Decisioning Service (ADS) 224, the ADS comprising another computerized network entity which is adapted to determine individual ones of the plurality of secondary content from the content store (not shown) to be inserted into the primary content and delivered to the client 106, based on e.g., selection applications or algorithms running on the ADS 224.

Exemplary apparatus and methods for selection of secondary content to be inserted (e.g., via a “targeted” approach) are described in co-owned U.S. patent application Ser. No. 11/186,452 filed on Jul. 20, 2005 and entitled “METHOD AND APPARATUS FOR BOUNDARY-BASED NETWORK OPERATION”; U.S. patent application Ser. No. 12/284,757 filed on Sep. 24, 2008 entitled “METHODS AND APPARATUS FOR USER-BASED TARGETED CONTENT DELIVERY” and issued as U.S. Pat. No. 9,071,859 on Jun. 30, 2015; and U.S. patent application Ser. No. 12/766,433 filed on Apr. 23, 2010 and entitled “APPARATUS AND METHODS FOR DYNAMIC SECONDARY CONTENT AND DATA INSERTION AND DELIVERY”, each of which is incorporated herein by reference in its entirety, although other approaches may be used consistent with the present disclosure.

In one embodiment, the infrastructure 220 of FIG. 2A is configured to generate a unique identifier (e.g., session ID, such as a globally unique ID or GUID, or identifier which is unique for each particular client device or process) for inclusion with a manifest file relating to delivery of primary content (e.g., video assets) requested by the user 107 via the client device. This approach could allow the architecture (including AMS 226 via ADS 224) to prevent false “counts” for secondary content (e.g., advertisements) which are associated with the primary content assets, such as might be instigated by a “bot” or other malicious entity.

In one exemplary implementation of the foregoing architecture, one or more “beacons” or indicators (including, without limitation, advertisement tags, web beacons, and metadata or data containers) are also embedded into e.g., the metadata of the secondary content, the secondary content itself, or associated with the URLs of the secondary content. In one embodiment, the one or more beacons or indicators may comprise quartile beacons, indicating that 25%, 50%, and 75% (and 100% if desired) of the individual one of the secondary content has been “consumed” by the client device 106 that is rendering the content. It will be appreciated that the term “consumed” as used in the present context may have various definitions, including without limitation: (i) receipt of a valid consumption request at the AMS 226; (ii) receipt of a data indicative of an actual decode of the relevant chunk(s), or (iii) receipt of data indicative of extraction of the beacon/indicator from e.g., the metadata of a received content chunk (without knowledge of actual decode by the client). In one implementation, the one or more beacons may comprise ID3 tags, such as for example as those adapted to comply with the requirements set forth in ID3 tag version 2.3.0 (see e.g., http://id3.org/id3v2.3.0), which is incorporated herein by reference in its entirety. Alternatively, another mechanism to carry or entrain metadata within an ABR streaming protocol can be used, such as without limitation an encoder-agnostic approach such as MPEG-DASH (aka Dynamic Adaptive Streaming over HTTP); see e.g., ISO/IEC Std. 23009-1:2012 published April, 2012, and incorporated herein by reference in its entirety. The embedding functions are performed by, in one embodiment, the encoder/transcoder 210, although depending on the scheme used, such “embedding” may be performed by other entities (such as where the tag or indicator is part of e.g., a URL or other data element other than the encoded content).

The encoded content is passed from the encoder 210 to the packager 212, where various service variants are generated and distributed to an origin server 201. The service variants created by the packager 212 correspond to the various services identified by the content providers 203. Thus, each service variant is, in the illustrated embodiment, provided a different playlist (or manifest) containing one or more triggers or markers for varying content based on various considerations. In addition, certain service variants may have triggers embedded in the manifest which other variants may not have.

In one embodiment, the triggers or markers contained in the primary content mark an event that is of interest. In an exemplary embodiment, the events of interest are secondary content (e.g., advertisement) insertion events. That is to say, the primary content is segmented at least at advertisement insertion breaks. The segmenting functions may be performed by, in one embodiment, a staging processor (not shown). Triggering functions may occur using e.g., in-band or other signaling. In one embodiment, the trigger comprises an Society of Cable Telecommunication Engineers (SCTE)-35 trigger of the type known in the art. Specifically, an SCTE-35 trigger is a cue message embedded in the transport stream which indicates an insertion event which is used to, inter alia, indicate advertisement insertion points (see e.g., SCTE Standards Document ANSFSCTE 118-2 2007 entitled “Program-Specific Ad Insertion—Content Provider to Traffic Communication Applications Data Model”, which is incorporated herein by reference in its entirety). In the exemplary embodiment of the present disclosure, the SCTE-35 cue is maintained within the manifest or playlist; it will be appreciated that traditional SCTE-35 cues may be used in addition to those used for embedding beacons or indicators into advertisements as described elsewhere herein. In one exemplary implementation, the SCTE-35 cues are transported in a binary structure in a MPEG-2 transport stream, and are converted to a ASCII- or XML-based structure and embedded in the manifest file which later can trigger the secondary content (e.g., advertisement) insertion.

Still further, the packager 212 may use a Placement Opportunity Interface Specification (POIS) as described by SCTE Standards Document ANSI/SCTE 130-1 200 entitled “Digital Program Insertion—Advertising Systems Interfaces”, which is incorporated herein by reference in its entirety, to signal to that supplemental content or advertising should be delivered via SCTE-35 triggers.

In one exemplary embodiment, the MSO or third party app 204 operative to run on the client(s) 106 is configured to enable a user to interact with primary content (e.g., network programming). For example, during playback of the primary content according to the playlist or manifest thereof, the app 204 may reach a trigger (such as a URL redirect trigger which is placed in a manifest at each instance of an SCTE-35 marker by the packager 212), indicating that supplemental content (e.g., trivia question), secondary content (e.g., advertisement for one or more products), and/or synced content (e.g., a plurality of possibly answers to the trivia question or options to purchase the one or more products) is needed. The app 204 may, for example, include the necessary code to examine and extract the aforementioned program ID (e.g., GUID) and/or beacons from the received manifest file, and utilize them in forming requests to the CDN 201 and/or the synchronization (sync) server apparatus 205 for content delivery, or for informational purposes to the content provider(s) 203 or other external entities (e.g., messages indicate of beacons for percent completion of the content), which may be pre-processed by a gateway server apparatus 218 (described in more detail infra).

It will also be appreciated that the IP gateway's (218) functionality may be integrated with the blockchain Gateway 214, e.g., as one physical server.

The trigger event in one exemplary implementation causes the client 106 to request an appropriate URL or program ID from the synchronization (sync) server apparatus 205. The sync server 205 then correlates the URL or program ID to information regarding which “secondary” (e.g., supplemental (e.g., trivia question), advertising, etc.) content should be synced to the primary content. In one implementation, the sync server 205 consults a list of pre-designated supplemental content provided by the content provider(s) 201 to determine which URL (i.e., the URL for which content) should be transmitted to the requesting device 106.

The sync server 205 (including in this embodiment a manifest manipulator (MINI) process 222 responsible for manifest changes and configuration) responds to the client device 106 with a decision which gets translated into a list of URL's that represent the “chunks” of the secondary content that collectively comprise supplemental content element (e.g., one or more trivia questions, an entire advertisement, etc.). In an exemplary embodiment of the present disclosure, the sync server response also contains one or more unique identifiers (such as, e.g., a session-specific identifier such as a globally unique identifier (GUID) or universally unique identifier (UUID) that uniquely represent the client's request for a session (e.g., a video session)), or yet other types of identifying information. The data structure (e.g., list) of supplemental/secondary content-related URLs is then inserted into the manifest or playlist that contains the list of addresses or URLs for the associated primary content, whether in addition to, or in substitution of, the primary content URLs. The purpose of implementing the unique identifiers is so that the client is required to request at least one of the actual secondary/supplemental content “chunks” using the included identifier, in order for an accounting request to be considered legitimate.

For example, in one exemplary implementation, the client 106 parses the manifest and requests from the CDN 201 (or other network, such as the ADS 224 shown in FIG. 2A) the first URL for each unique secondary/supplemental content request (referred to herein as an “accounting” URL), which also contains the unique identifier for the session. The CDN 201 (or, e.g., ADS 224) verifies that the unique identifier is the actual unique identifier that the CDN 201 (or ADS 224) had (recently) generated. Upon a successful validation, the CDN 201 (or ADS 224) considers the client's 106 request based at least in part on the verification of the accounting URL to be legitimate.

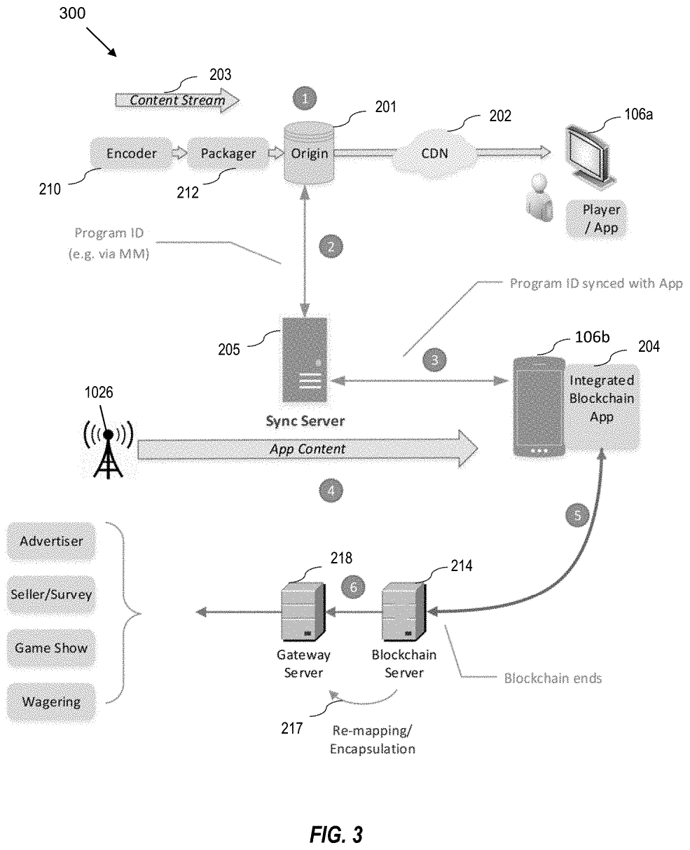

FIG. 3 is a graphical representation of one exemplary implementation 300 of the architectures 200, 220 of FIGS. 2 and 2A, shown as steps 1-6 therein.

At step 1, digital TV content (e.g., network programming) is delivered to the client device 106a (e.g., a TV) via CDN 202. It is appreciated that although the origin server 201 and CDN 202 (e.g., access/edge network) are shown as separated entities in FIG. 2B, a single entity can perform the functions thereof (i.e., each can be considered part of the CDN, as shown in FIGS. 2 and 2A).

In one implementation, the end-user is watching TV content (e.g., a program) on a display apparatus 106a (e.g., a TV), and then the user engages with a mobile device 106b.

At step 2, the sync operation is initiated. As described elsewhere herein, the sync operation may be initiated by, e.g., (i) startup of the app 204, (ii) by the user selecting a “sync” option on the mobile device 106b, (iii) automatically by a trigger event (e.g., the app 204 detecting a marker (e.g., SCTE marker), detecting an audible/visual que of the primary content, etc.), or by any various means known in the art. Based on the initiation of the sync operation, the sync server 205 in one variant correlates the current program's (e.g., network programming) ID to a user's mobile device that is associated with the end-user device. In one implementation, device MAC address information, obtained during the application set-up or registration phase, is used as a basis of the correlation. The sync server 205 provides the ID of the program on air, which then is used by the mobile application to download the synced content from the secondary content database server. In effect, the current program ID maps/correlates to the secondary content.

At step 3, the sync server 205 supplies the currently tuned program ID to the mobile app 204 in order for the mobile app 204 to retrieve corresponding “synced” content.

At step 4, the mobile app 204 retrieves one or more synced content elements.

At step 5, the mobile app 204 and blockchain-based digital wallet are engaged for user interaction.

At step 6, the blockchain server 214 acts as an end-point of the intra-network.

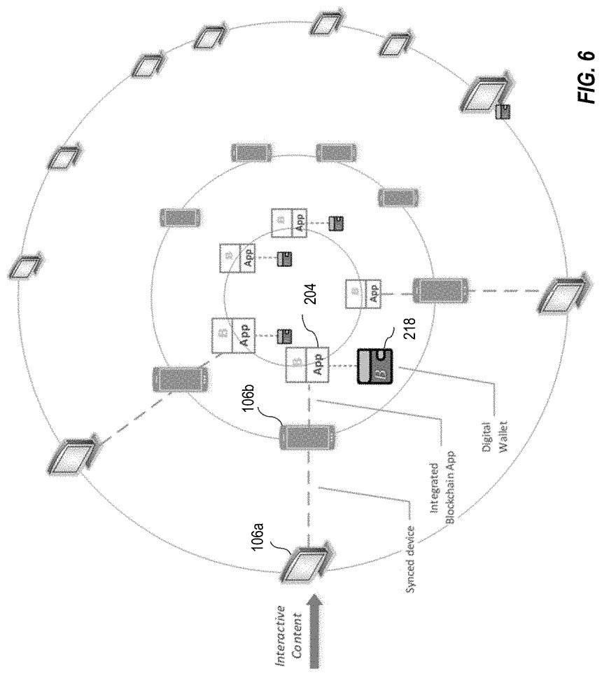

In one embodiment, the private and permissioned blockchain (see discussion of FIG. 6) includes blockchain-related applications with digital wallets (located in a multitude of user mobile devices). The architecture forms a distributed ledger. As shown in FIG. 3, the blockchain is in this embodiment confined to a single domain within a service provider network. The blockchain server in FIG. 3 ensures, among other functions, the debiting of crypto-currencies to individual wallets/accounts. For example, imagine the viewer answered a question correctly and is entitled to a $1 reward. Assume the advertiser digital wallet containing $1000 and resides in the blockchain server (as a proxy). The smart contract triggers the payment once the Oracle validates user response as the correct answer. The user digital wallet is remitted $1 and the advertiser wallet is adjusted to $999.

In some configurations, the blockchain server functions as an end point if the blockchain network does not extend beyond that (e.g., to the outside cloud network). Any communication with the “outside world” is via the gateway server, one role of which is to encapsulate blockchain data (e.g., using IP v4 or v6 headers to data packets).

Communication with external entities is effected via a gateway server 218 using cryptographic public keys as addresses/identifiers.

It is further noted that blockchains have seemingly contradictory primary attributes; i.e., anonymity and transparency. Anonymity is achieved through PKE and is an important attribute in the context of the exemplary embodiments of this disclosure. Transparence stems from the immutability of block creation process, including creating Merkel trees, generating validated block hashes and forming blocks into an interconnected unalterable chain. It is noted that while block formation is often a good business practice for record keeping, its use is not a requirement, including for various aspects of the disclosure described herein.

### Exemplary Use Cases

In various embodiments, the network infrastructure 200 and 220 of FIGS. 2 and 2A can be utilized for enabling direct user interaction with content in accordance with a blockchain-based protocol. The direct interaction includes interaction (including manipulation) with content by a single user. Various exemplary implementations of or models for direct interaction according to the invention are discussed herein below.

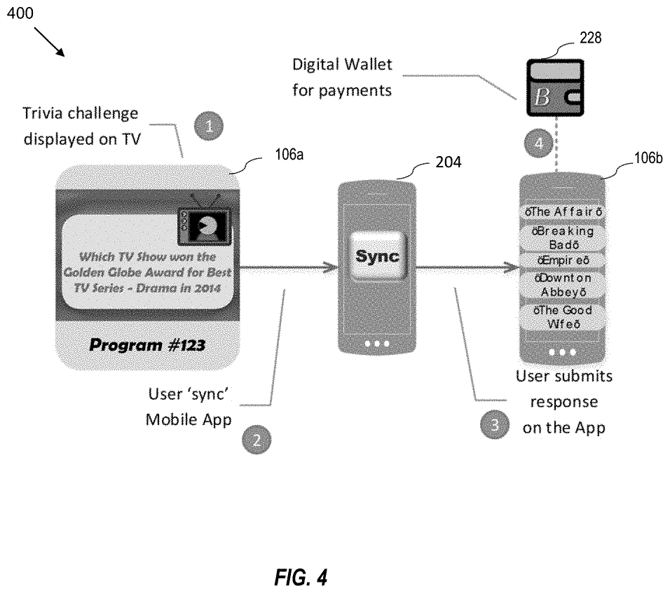

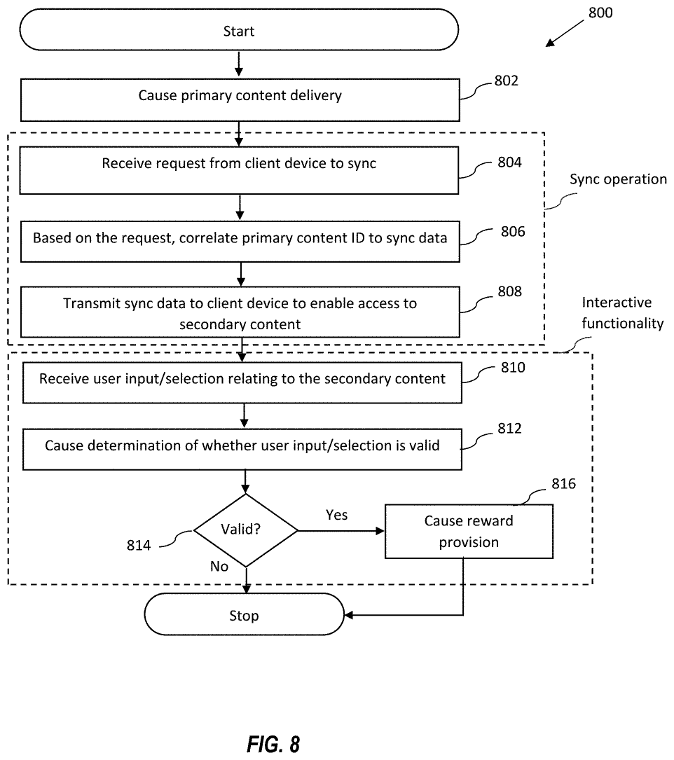

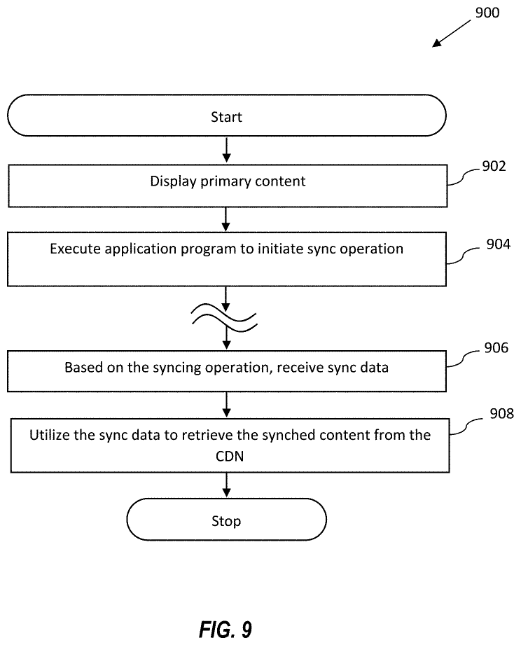

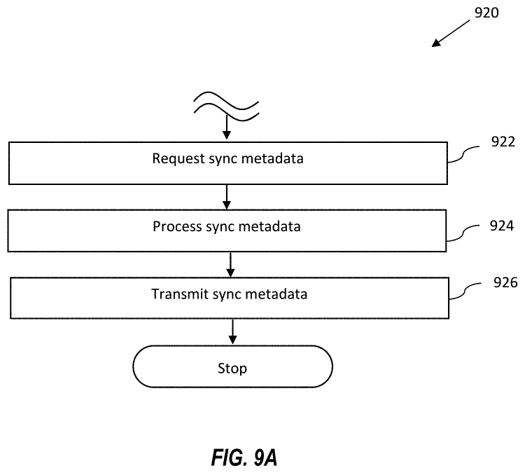

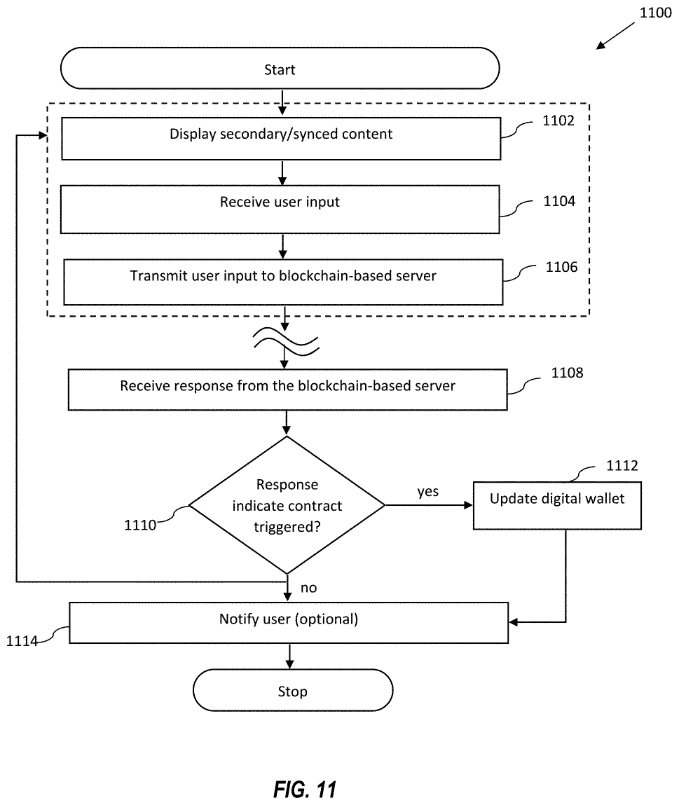

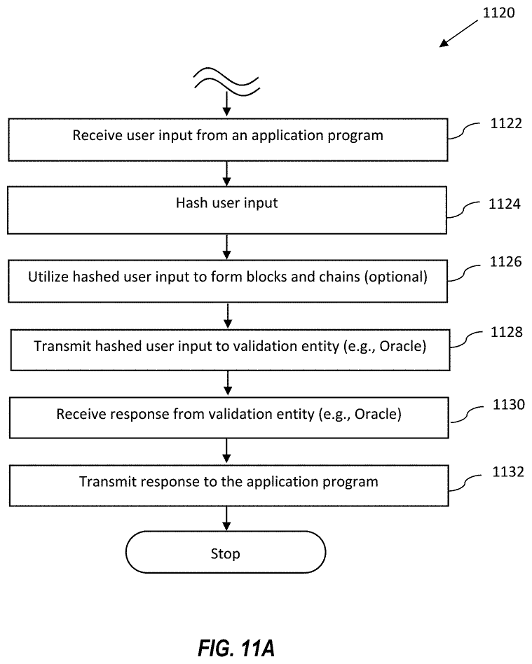

Various embodiments of exemplary infrastructure, methods, and apparatus disclosed herein includes the steps of displaying network content to the user (see e.g., step 1 of FIG. 4; step 802 of FIG. 8; and step 902 of FIG. 9 discussed below). The sync app 204 operative on the user device 106b enables the user to interact with such content by subsequently displaying synced/corresponding/secondary content (see e.g., step 808 of FIG. 8; step 908 of FIG. 9; and step 1102 of FIG. 11). The sync operation performed by the sync server 205 may include for example enabling a user to, e.g., directly interact with content, as well as create a personal channel for (a) selling/auctioning, (b) broadcasting, (c) commentary, and (d) exercise/workout. In addition, each may be performed by leveraging premises bandwidth to a consumer device at a consumer premises, as well as wireless/5G capabilities on portable devices.

In one embodiment, the aforementioned personal channel may be a virtual channel of the type discussed in previously referenced co-owned, co-pending U.S. patent application Ser. No. 12/414,554 filed on Mar. 30, 2009 and entitled “Personal Media Channel Apparatus and Methods”, which is incorporated herein by reference in its entirety. As discussed therein, a substantially user-friendly mechanism for viewing content compiled from various sources, including, inter alia, DVR, broadcast, VOD, Start Over, etc., and particularly that content selected to align with a user's preferences, is displayed as a substantially continuous stream as part of a “virtual” user-based channel. The “virtual channel” acts as a centralized interface for the user and their content selections and preferences, as if the content relevant to a given user were in fact streamed over one program channel. In another aspect, client applications (e.g., those disposed on a subscriber's client devices and/or network servers) are utilized to compile the playlist based on user-imputed as well as pre-programmed user profiles. Various feedback mechanisms may also be utilized to enable the client application to “learn” from the user's activities in order to update the user profile and generate more finely-tuned and cogent recommendations. Client applications may also be utilized to manage the seamless presentation of content on the virtual channel, and locate/flag various scenes inside selected content for user viewing or editing or insertion into other streams or playlists. The sync server 205 can provide the personal channel to any subscribers.

a. Selling/Auctioning

In one embodiment, the network architectures, apparatus, and methods disclosed herein may be used to enable a user to create a sales channel composed of e.g., currently broadcast content, recorded content, web or other network-based content, and/or user-generated content (i.e., that generated indigenously by the user, such as via their webcam or portable video camera or smartphone), etc. For example, the network content (e.g., network-sourced content) sent via the downlink can be an ocean or landscape or sky scene, and the user may merge their items for sale with the network content to create more dynamic content.

As previously discussed, consumers are often not enthusiastic about sales gimmicks such as, “first 100 callers get an extra discount”, for at least two reasons: (i) privacy concerns associated with divulging personal data, and (ii) veracity of seller claims are doubtful, as they are hard to prove.

Advantageously, the various aspects of the present disclosure resolve the privacy concerns referenced above via public/private key architecture. Moreover, the latter issue (ii) is addressed via “smart contracts,” which automatically trigger payments once the conditions are met.

As a brief aside, smart contracts (aka “chaincode”) are code snippets with conditions and actions listed. They generally run on top of the blockchain network layer. In some implementations, smart contracts trigger payments once the conditions of a transaction are met.

b. Wagering on TV Shows/Trivia Questions

In one scenario, TV viewers see trivia questions flash or otherwise be rendered, such as at a portion (e.g., bottom) of the screen and/or audibly, and respond anonymously via the mobile app 204. Questions may range from e.g., TV show related “whodunit” type to celebrity trivia, product purchases, user comments, betting, etc. Digital wallets in the blockchain enable an anonymous payment system. To prevent a deluge of unwanted texts, the concept of “Reputation Index” (similar to e.g., prior art Yelp and similar) is introduced. To avoid spam, the viewers may limit the subscription level (e.g., friends or other prescribed contacts only). Additionally, the user may limit the audience to those with Reputation Index above “four stars,” for example.

c. Game Show Voting/Customer Survey

Popular TV shows promote viewer engagement through voting (via texting/calling). Consumers are somewhat reluctant to participate out of privacy concerns. Various aspects of the present disclosure provide anonymity in some implementations via the PKE (Public Key Encryption) feature of blockchain-based architecture. The integration with service provider (e.g., cable MSO) network ensures that “rogue” or unsolicited voting is prevented. Similarly, consumers that usually shun away from product or political surveys may find the proposed solution allays their privacy concerns, and are hence more likely to participate in such activities.

d. Advertising Product Promotion

An advertiser may decide to pay viewers a prescribed or even variable amount (e.g., $0.001) for watching a new advertisement. As a brief aside, advertisement viewability can be measured with percentile beacons, which are electronic signals emanated when a portion of the ad is aired (such as those previously referenced herein). For instance, when a prescribed level such as three-fourths of an ad is viewed, it will trigger the 75th percentile beacon). Consumers will remain anonymous (via PKE), and payments made to their digital wallets. Any concerns about bots (masquerading as real customers), would be allayed because the calls can only be originated from Service Provider authorized gateways 218. Hence, one advantage of the exemplary architectures 200, 220 of the present disclosure is that in one exemplary embodiment, unlike in a public blockchain, the network owner/operator (e.g., MSO) has full control of the private blockchain.

e. User Commentary

In yet another embodiment, the user may further create a running commentary to accompany any content the user chooses. For example, the user may play the role of an active viewer to network content by chiming in with jokes, information, etc. during a content playback. The creator may in some instances be a celebrity (such as an actor, director, etc. of the program) or may gain notoriety via the commentary. Real-time commentator type of broadcasting is also very popular for gamers (e.g., Twitch) to allow audiences to participate the actions being played by gamers. See e.g., co-owned U.S. patent application Ser. No. 13/619,951 filed Sep. 14, 2012 and entitled “APPARATUS AND METHODS FOR PROVIDING ENHANCED OR INTERACTIVE FEATURES,” which is incorporated herein by reference in its entirety, which discloses exemplary methods and apparatus for utilization of enhancement content or data consistent with the present disclosure.

With the high bandwidth availability in the upstream (premises-to-network) via an IP connection using 5G NR, and downstream (network-to-premises) directions via, e.g., in-band channel or DOCSIS QAM, the communications between the sync server 205 and the client devices 106 are effectively real time, and allow for substantially latency-free operation.

### Exemplary Operations

FIG. 4 is a graphical representation of one exemplary implementation 400 of a synchronization operation, shown as steps 1-4 therein.

It is noted that the present disclosure contemplates use of a single client device 106 (as shown in FIG. 2A) or multiple devices (as shown in FIG. 2), in providing the disclosed functionality. For example, in one exemplary implementation of a synchronization operation shown as steps 1-4 in FIG. 4, multiple devices are used, and per step 1, during playback of the primary content (e.g., program #123) on the display device 106a, supplemental content (e.g.,. a trivia question) may be displayed in a portion of the screen (e.g., the bottom of the screen) or on a separate device (e.g., social network app, separate browser window etc.) so as to not interfere with the primary content). Supplemental content can take several forms, including without limitation supplemental content delivery before and after synchronization.

Supplemental content delivered before the synchronization may be used for e.g., publicity and to entice the viewers. For instance, a TV program may display the trivia question intermingled with primary content. e.g. “What fictional city does the Simpson family live in?” In that case, the trivia question is displayed before the sync button is pressed. To respond, the viewer must invoke the application program, which in turn displays the question and how to respond.

Supplemental content after the synchronization may be e.g., only a redirect or other short message; e.g., “To win [X], open the mobile app to see questions about the episode”. In some such cases, the synchronized content is not displayed until the sync button/function is selected. Upon syncing, the mobile app obtains the program ID from the sync server to retrieve secondary content from the CDN (or from the server database location for the secondary content on the Internet). The user response is sent through the blockchain supported network. Note that in one exemplary embodiment, the user's response does not route through the sync server.

In yet other scenarios (e.g., polls, surveys, opinions), the synchronized content is displayed on the mobile app after the sync function is selected. However, the content programmer or network may decide to convey e.g., the trivia question, poll etc. before the sync operation (such as for publicity reasons); the user simply sees the question repeated (once from the TV and again in the mobile device app),In each case, once syncing is performed, the app downloads the secondary content (e.g., trivia question etc.), such as from the database server.

Returning again to FIG. 4, per step 2, the user 107 may then select, via the mobile app 204, a “sync” option displayed on the mobile device 106b, which causes the mobile device 106b to communicate with a synchronization (sync) server apparatus 205 (e.g., using REST protocol).

In one implementation, the RESTful HTTP(s) request GET method utilizes a Request/Response protocol as shown in Table 1 below:

TABLE 1

| HTTP | |
|---|---|
| Message | |
| Type | Example Protocol |
| Request | https://[wap_ip_address]:[port]/wap/v1/ |
| | retrieveLocation?deviceIdentifier=identifier_value |
| Response | {“result”:[UE Location]} |

In the example of Table 1, the “device identifier” is formed using (i) the MAC address of the a wireless access point (WAP) apparatus where the UE is attached, and (ii) the IMEI number of the UE, although it will be appreciated that other data and/or combinations may be used for this function. Specifically, in one variant, the device identifier includes the MAC of the WAP to identify the WAP, and an IMEI of the UE for identification of UE by the WAP for location determination. This can be defined with a delimitation character in between the two numbers or alternatively each of these values can be provided in two different parameters; e.g., deviceIdentifier=IMEI and wapIdentifier=MAC.

Per step 3, the user is presented with “synced content” (e.g., a plurality of possible answers to the trivia question) on the client (e.g., mobile device 106b). The user 107 inputs their response via the user interface (e.g., via the touch screen of the device 106b).

Per step 4, the user response is transmitted via the blockchain server 214 to an outside entity (for example, the content source or programmer who created the quiz). Communication with external entities is effected via a gateway server 218 using cryptographic public keys as addresses/identifiers. The answers/responses are compared with a verification ledger/repository or “Oracle” 216 (or submitted to Advertiser/Programmer for further action). Any payments/wins are subsequently delivered to the digital wallet.

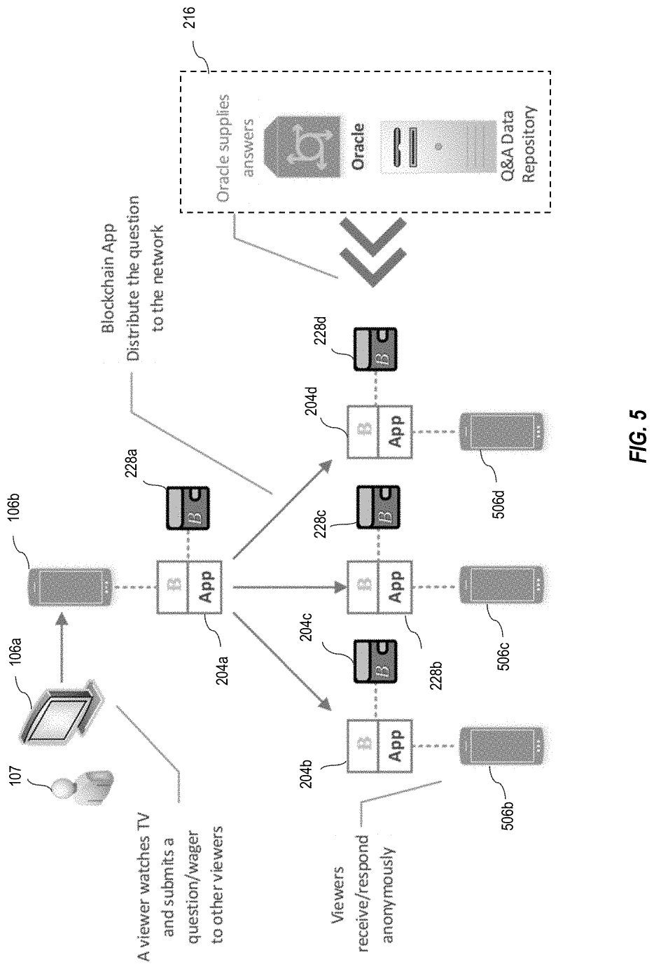

Now referring to FIG. 5, a graphical representation of one exemplary implementation of mobile application interaction with blockchain-based apparatus, in accordance with the present disclosure, is shown. More specifically, FIG. 5 depicts the previously referenced wagering use case, by way of example. The mode of operation for this illustration is peer-to-peer. In this scenario, while watching the TV content, the viewer 107 submits a question (or a wager) to other viewers 506b, 506c, 506d.

Once the mobile phone app 204a is turned on, it synchronizes with the TV program being watched via the network infrastructure. The viewer 107 is now able to interact with other participants either by submitting a question or placing a wager. The viewers would respond anonymously, and any wagers or transactions are handled by blockchain-based network infrastructure previously described. The correct answer to the question may reside with an external authoritative server (Oracle) 216.

Now referring to FIG. 6, a graphical representation of one exemplary implementation of integrating digital content and mobile applications, in accordance with the present disclosure, is shown. FIG. 6 illustrates how the various user devices in the multi-device architecture interact. In one exemplary scenario, a TV viewer watches a program while having the mobile phone 106b on the side. If interactivity is desired, the user may turn on the mobile app, which is then synced to the program being watched via the network infrastructure (previously described). The app 204 has a dual role in this scenario: (i) it interfaces with digital media stream (e.g., IPTV) and synchronizes to the program content; and (ii) it is also a blockchain-based app with transactional capability, and acts as a digital wallet.

In is noted that in the context of FIG. 6, the “sync” operation does not equate to duplicating the TV feed. Instead, the ancillary device 106b (mobile/tablet) will display the “synced content” applicable for the specific program. For example, in FIG. 5, the user's TV is tuned to channel/program #123. The mobile app displays the associated synced content for that particular program (in this case the trivia question, publicity content, etc.), and possible related information such as responses to a displayed content such as responses to a trivia question). In one variant, the sync server involvement is only for the synched content (e.g., trivia question); data relating to the user response (e.g., user selection of a possible answer) is transmitted from the mobile app to the server via either a blockchain server 214 to ledger 216 (e.g., Oracle), or via the blockchain server 214 to the gateway server 218. In one configuration, the blockchain server 214 accounts for any payments using blockchain functionality.

As alluded to above, trivia questions are but one example of synched content that may be used consistent with the disclosure. The disclosed models encompass many other scenarios where today the viewers are reluctant to offer opinions publicly. —For instance, one may like a given commentator's program on a given network (e.g., CNN) for its depth of analysis, but dislike certain aspects of the program (e.g., lengthy, convoluted question-posing style). The present disclosure offers a framework for such communication from the audience, although no monetary transactions or other consideration are involved. This mode is also distinct from simply writing an opinion on a web page for the network or blog, for example. While the responses still remain anonymous (due to PKE), they have originated from actual registered viewers, and as such the host/commentator may be more inclined to respond.

Another use case is the informal and anonymous voting/polling (with or without monetary rewards). For instance, otherwise allegedly “shy” voters who might not wish to participate in a survey or disclose their true feelings towards a candidate when participating via prior art approaches may be more inclined to do so under various embodiments of the present disclosure, due to inter alia, the anonymity involved. Users can express their true feelings without having fear of either scorn from the interviewer, manipulation of their words or questions asked based on their response(s), or the response being “traced back” to them.

As shown in FIG. 6, a plurality of digital media receivers 106a are attached to a content distributor network. The multiple users each also have ancillary devices 106b synced to the current program being aired. The blockchain-based app 204 is integrated for secure interactions between users in a peer-to-peer fashion, via the interposed network (not shown).

Accordingly, the synced components include: (i) at least one digital media receiver 106a (e.g., Smart TV/ Roku, Apple TV, or similar), (ii) at least one ancillary device 106b (e.g., mobile/tablet device synced to the same service provider network), and (iii) an integrated blockchain app 204 with digital wallet for transactions.

It will also be appreciated that the connection of each ancillary or mobile device 106b may be via a different service provider and PHY, with only logical connection to the MSO infrastructure 200, 220 required. For example, one mobile device may use a WLAN wireless connection via an AP which is backhauled to the MSO network via a DOCSIS modems and CMTS (see FIG. 1), while another device 106 may use a cellular service provider or MNO network (e.g., 3GPP LTE or 5G NR enabled) which is communicative with the MSO core via the MNO core (e.g., EPC/5GC) and related packet gateway functions. Hence, the physical transport is effectively immaterial.

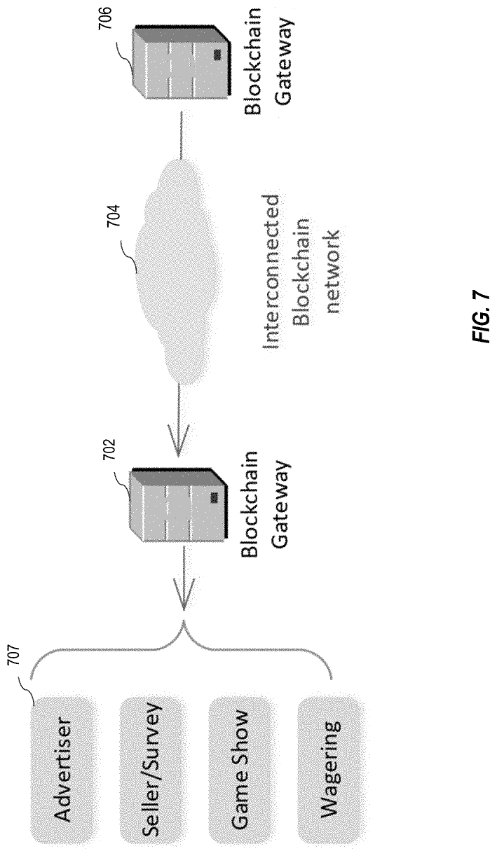

FIG. 7 is a graphical representation of one exemplary implementation of an interconnected blockchain-based network, in accordance with the present disclosure. Specifically, the exemplary embodiment of FIG. 7 depicts a federated blockchain network (meaning multiple blockchain domains, physically disparate but connected). These domains communicate via IP Gateway servers (see FIG. 3) as entry/exit points to each network. In this architecture, the blockchain gateway at the Advertiser/vendor end 702 communicates with the public Internet (or managed intranet)/IP cloud 704, which is communicative with the blockchain gateway 706 at the IPTV provider end vMVPD cable advertiser/vendor end. The blockchain network 707 of e.g., third party, such as the advertiser, is also in data communication with the gateway 702.

One operational scenarios for the illustrated architecture (also referring back to FIG. 4) is as follows. The advertiser poses a trivia question on the user's TV or via the mobile app. The end-user enters the response on the mobile app, the response which is transmitted via the service provider's internal blockchain network to the blockchain gateway 706. The IP Gateway encapsulates blockchain data inside one or more IP packets and transmits the data via the network 704. At the receiving end (advertiser IP gateway); there, the IP header is stripped and the blockchain content is supplied to the Advertiser blockchain gateway. The advertiser server 707 communicates with the Oracle server (which is in this embodiment is within the advertiser domain) to validate the answer. If the answer is correct, then the advertiser network invokes the smart contract.

As far as a return path from the advertiser network to the service provider (e.g., cable MSO or vMVPD), the message to update a specific user's account (e.g., by some consideration such as $1) is supplied to the advertiser's IP gateway. There again an IP header is added and the data transmitted through the network 704 to the service provider's IP Gateway server 218 (see FIG. 2). The gateway server strips the IP header and supplies the blockchain based message to the blockchain gateway. As part of the smart contract invocation, the winning user's digital wallet is updated with the consideration (e.g., +$1).

The distributed-ledger copies in the network make the following updates in this scenario: (i) subtract $1 from advertiser account, and (ii) add $1 to the winning customer's digital wallet.

In one variant, the blockchain-based protocol of the present application is internal to the enterprise (i.e. behind the firewall). In an alternative variant, the blockchain-based protocol could be shared by multiple enterprises via VPN tunnels. Such an arrangement is known as a federated/consortium blockchain.

In one exemplary deployment scenario, the advertiser/programmer 707 is also running a blockchain-based protocol. In such a scenario, the configuration as shown in FIG. 7 is used to extend the blockchain-based applications to seamlessly transact with other chains. One salient difference in this architecture as compared to the configuration 300 of FIG. 3 is that the gateway server 218 of FIG. 3 is modified in FIG. 7 to incorporate blockchain functionality, whereas in FIG. 3, the blockchain terminates internally as shown (step 5).

It is noted that in the “federated” architecture of FIG. 7, the blockchain virtually extends to other domains; i.e. advertiser has its own blockchain domain, but to communicate they each need an IP or other gateway function as the entry/exit point of the internal network. In this context, re-mapping' is the encapsulation of native blockchain data inside an IP packet for transmission. Also, when an encapsulated IP packet (e.g. from advertiser network) is received by the gateway server (218 in FIG. 2), the IP header is removed and blockchain data is passed on to the blockchain server 214 for processing.

In one implementation, data encapsulation or ‘tunneling’ of the type common used in packet networking. (e.g., voice packets are embedded in IP packets in VOIP) is utilized, with remote sever ‘ping’ using ICMP messages being encapsulated in IP. The interconnected Blockchain of FIG. 7 illustrates the use of IP encapsulated, encrypted data that is passed over a public network, although it will be appreciated by those of ordinary skill that other approaches may be used with equal success.

### Methods

Referring now to FIG. 8, one exemplary embodiment of a method 800 for effecting a synchronization operation and enabling interaction with content in accordance with the present disclosure is described.

Method 800 starts with step 802, at which one or more primary content elements (e.g., network-sourced content) is delivered. In some embodiments, the network content is delivered from the CDN 201. In one particular implementation of step 802 of the method 800, a content provider 203 or other network entity creates a cross-reference list of identifiers (such as e.g., headend IDs, geographic or location identifiers, system identifier, market identifier, program ID, stream ID) to appropriate services based on negotiated viewing rights. Each available service may be associated to e.g., a relevant geographic region, and/or according to other criteria. The content provider 203 may publish the matchup of headend ID (or other ID as indicated above) to particular programming for use by the sync server 205 (per step 806, discussed infra).

In various embodiments, the network programming can include broadcast video and audio programming, a live program delivered by the broadcast television network, video-on-demand (VOD) content, DVR, linear broadcasts, start-over content, IPTV content, third party customized background scenes, gaming content, etc.

At step 804, data representative of a request to sync content or initiate a sync operation is received. In one exemplary embodiment, the request may be automatically sent from the client device 106 based on startup of the app 204 operative to run on the client device 106. In another embodiment, the request may be sent from the client device 106 based on a user selection made via one or more selection mechanisms (e.g., other remote control buttons, textual commands, touch screen interfaces, etc.) associated with the app 204. In yet another embodiment, the request may be sent from the client device 106 based on a trigger event. For example, during playback of the primary content according to the playlist or manifest thereof, the app 204 may reach or detect a trigger (such as a URL redirect trigger which is placed in a manifest at each instance of an SC1E-35 marker by the packager 212), indicating that corresponding/supplemental content is needed, and issue a request therefor. The app 204 could also be configured to use one or more sensors of the client device 106 to monitor visual or audible queues in the primary content that would trigger the request.

Additionally, in one exemplary embodiment, the client device 106 communicates the data representative of the request to the sync server 204 via use of REST protocol, as described elsewhere herein. At step 806 of the method 800, based on receipt of the data representative of the request to sync content or initiate the sync operation (per step 804), the program ID (PID) or other identifier (e.g., URL or IP address) associated with the primary content is correlated to sync data associated with appropriate corresponding/supplemental/secondary content. The PID/identifier can be obtained in various ways according to different embodiments. In one embodiment, the sync server 205 obtains the PID the matchup of headend ID published by the content provider 203 as described above with respect to step 802.

In another embodiment, the MM 222 queries the CDN 201 or other network entity (e.g., ADS 224) for information regarding which of a plurality of secondary content should be synced to the content. The CDN server 201 or ADS 224 consults a list of pre-designated secondary content provided by the content providers 203 (or otherwise, such as being based on one or more local advertising campaigns from e.g., an content distributor (MVPD)) to determine which URL (i.e., the URL for which content) should be transmitted to the requesting device 106.

At step 808, the sync data is transmitted to the client device 106 (and/or the app 204) to enable the access to the secondary/supplemental content. That is, the client device 106 and/or the app 204 utilizes the sync data to request synced content from the CDN 201. In one embodiment, the sync data or metadata comprises Program ID data (e.g., #123). This data is passed by the sync server to the mobile app, which then use an HTTP GET (for example) to download the synced content (e.g. trivia question) from the CDN. While CDN is one possible location, any other location on the cloud is feasible for location (topologically) of the secondary content database server. Within the database server for synced/secondary/supplemental content, resides data relating to a mapping of program IDs to synced content. (e.g., Program#123 to the corresponding trivia question(s)).

It is appreciated that the “synced content” in this context refers to the primary content temporally or contextually synchronized with the secondary/supplemental content; however, the primary and supplemental content can either be displayed together (via, e.g., multiplex, overlay, Picture-in-Picture (PiP), etc.) or can be displayed separately (i.e., on separate screens) so as to not interfere or distract from one another. For example, during playback of the primary content, the app 204 could utilize the sync data to retrieve the supplemental content (e.g., a trivia question), which may be displayed at the bottom of the screen of the device displaying the primary content (or on a separate device, social network app, separate browser window etc.). The app 204 is therefore disposed on each device that displays the supplemental content in this configuration.

At step 810, user input, or one or more user selections, relating to the secondary/supplemental content is received. The user may issue the user input/selection(s) via the app 204 on the client device that is displaying the primary content and/or the supplemental content, or on a separate client device. The user input/selection(s) may include, for example, the users answer to a trivia question, placing a wager/bet, voting (such as for a product or survey), purchasing a product, or selecting or viewing an advertisement/promotion.

At step 812, a network entity (e.g., blockchain server 214, gateway server 218, sync apparatus 205, or other network entity, depending on configuration) causes a determination of whether the user input/selection is valid. This validation may be accomplished in a number of ways, including authentication of cryptographic data, validation of the user ID/device-specific ID (i.e., to frustrate unauthorized devices from submitting inputs, validation of the substantive input or selection itself (i.e., is it within an allowable range or set of inputs/selections), or other aspects.

Based on a determination that the user input/selection is valid (per step 814), a reward may be provided to the user per step 816. The reward can include a product, service, credits, form of currency, etc. In one exemplary embodiment, digital currency is provided, which can be placed in a digital wallet associated with the user. However, a determination could be made that the user input/selection is not valid, in which case the user would not be rewarded.

It is further appreciated that variations of this reward-based approach can be implemented in accordance with the present disclosure. For example, a tiered or ranked approach could be used—e.g., first place (e.g., based on score or some other metric) receives a larger or more valuable reward than second place, and so forth. Temporal latency may also be considered; correct response received first may be rewarded differently than others arriving later.

Referring now to FIG. 9, one exemplary embodiment of a method 900 for effecting a synchronization operation via use of one or more client devices in accordance with the present disclosure is provided.

Method 900 starts with step 902, in which the client device(s) displays primary content. In one embodiment, the primary content may include network programming (e.g., broadcast content, VOD content, etc.). In other embodiments, the primary content may include “third party content”—e.g., content provided by a product seller, survey/poll/questionnaire maker, gaming programmer, etc.; therefore, the primary content may including surveys, betting options, questions or item lists for games, etc. In yet other embodiments, the primary content may include a combination of both network programming and third-party content via any means known in the arts (e.g., multiplex, overlay, PiP, etc.). For example, a horse race may be broadcast on cable TV over a CDN 201, 202, and a list of the horses in the race may be overlaid at the bottom of the screen. As another example, a TV program (e.g., Friends) may be displayed, and a question regarding the particular scene currently displayed is overlaid on a portion of the screen.

At step 904, the app 204 is executed to initiate the sync operation.

At step 906, based on the execution of sync operation, sync data is received. The sync data may, in one embodiment, include metadata relating to the current program (e.g., metadata indicating the list of horses in the race, or metadata indicating the question regarding the particular scene currently displayed).

Lastly, at step 908, the sync data is utilized to access/retrieve the synced content from the CDN. The synced content may include, e.g., a list of possible answers to the question displayed, or a list of selection options corresponding to the list of horses in the race, per the respective scenarios discussed supra.

Referring now to FIG. 9A, one exemplary embodiment of a method 920 for effecting a synchronization operation via use of the sync server 205 (and/or MM 222) in accordance with the present disclosure is provided.

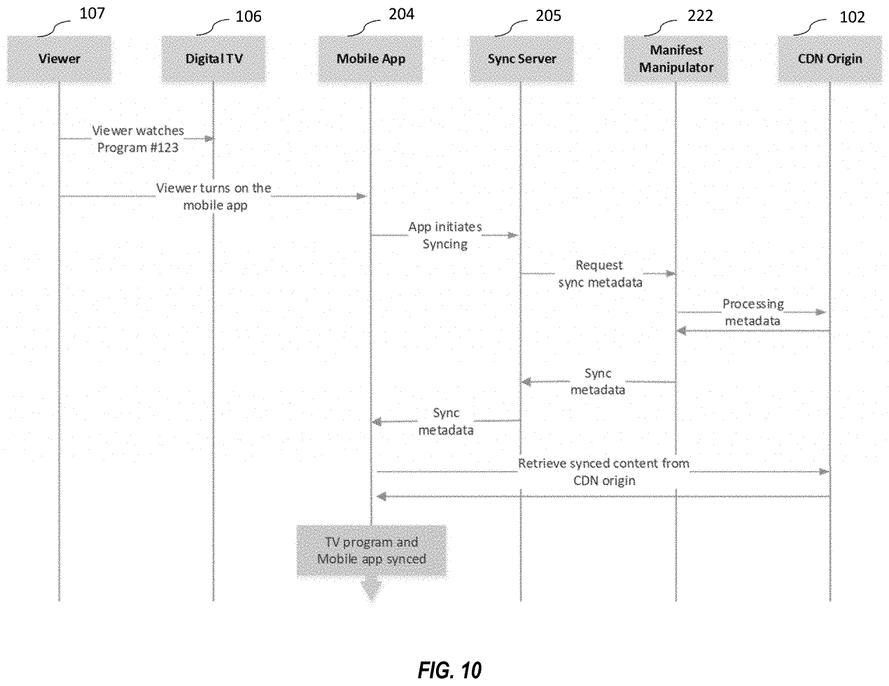

At step 922, the sync server 205 (and/or MM 222) transmits data representative of a request of sync data (e.g., metadata) to the appropriate network entity (e.g., MM 222, CDN 201, ADS 224, or other network entity). For example, in one exemplary embodiment shown in FIG. 10, the sync server 205 may issue the request to the MM 222. In another embodiment, the MM 222 may issue a request to the ADS 224.

At step 924, the sync server 205 (and/or MM 222) processes the sync data.

At step 926, the sync server 205 (and/or MM 222) transmits the sync data to the client device 106 (and/or app 204). As previously referenced, the sync metadata is the information needed to perform the sync function, such as program ID data, channel ID data, program time data, etc. that the viewer is currently engaged in. Once that data is supplied to the sync server (e.g. via MM (manifest manipulator), the latter stores that data in its database. During pre-registration process (done beforehand), the sync server learns that the mobile app from the particular mobile device is tied to the same end-user home device. This mapping can be accomplished by e.g., supplying the MAC addresses of each device during app set up/registration, or other means such as accessing a user device database maintained by the service provider.

When the end-user opens the app on the mobile phone (or second screen) and selects the sync function, it sends a request to the sync server. Once the sync server receives the session initiate signal from mobile app (occurs when sync function is selected by the user), first it identifies the relation between mobile app and the home device (via MAC comparison). Once that is established the sync server provides the aforementioned metadata (including e.g., program ID#123) to the mobile App. The mobile app then makes a request to the database server containing the secondary/supplemental/synced content data, such as the trivia question. This database server may be integrated with CDN origin server (or a cached server closer to the user), in which the primary content is stored. Alternatively, it may be disposed in a separate location in the cloud such as in the programmer's network domain.

FIG. 10 is a ladder diagram illustrating one exemplary embodiment of signal flow for a syncing process, according to the present disclosure. It will be appreciated that FIG. 10 illustrates concepts are equally applicable to the architectures 200, 220, 400 of FIGS. 2, 2A, and 4 respectively.

As shown in FIG. 10, a user/viewer 107 first watches a program (e.g., program #123 in FIG. 10) on a client/display device 106 (such as a digital TV 106a). The viewer 107 then turns on or invokes the application (app) 204, which initiates the synching process. As previously shown, the app 204 can reside on the client/display device 106, or can reside on a remote client device (such as a mobile device 106b), or be distributed across multiple devices. The app 204 initiates the synching process by communicating with the sync server apparatus 205, such as by issuing one or more messages to target processes or addresses to cause the sync server 205 to request the sync metadata.

The sync server 205 then issues data representative of a request for the sync metadata to the manifest manipulator (MM) 222, which in one variant can reside on the sync server 205. The MM can then retrieve the sync metadata from the origin server apparatus 102, and process the sync metadata as needed for delivery to the app 204.

The sync server then provides the processed sync metadata to the app 204, which uses the sync metadata to retrieve the synced content from the origin server 102.

In one embodiment, the program content (e.g. Program #123 video) and the synced/secondary/supplemental content (e.g. trivia question) come from the content programmer, or a proxy agent therefor. Since the primary content resides on the CDN origin, the secondary content can be stored there as well, but not required. As previously described, the primary and supplemental content are synced when the ‘sync’ function on the mobile app is selected. The data needed for syncing (including the device IDs belonging to the same end-user—such as MAC addresses—are supplied during the set up phase. In one variant, the mobile app makes the request to retrieve ‘synced content’ via a protocol such as HTTP.

Referring now to FIG. 11, one exemplary embodiment of a method 1100 for blockchain interaction in accordance with the present disclosure is provided.

Method 1100 starts with step 1102, at which one or more secondary content elements (e.g., synced content) is displayed. In some embodiments, the secondary/synced content is delivered from the CDN 201 and displayed on a client device (such as display device 106a).

At step 1104, user input is received. The user input can be input on the same device that displays the synced content, or on a different device. For example, in one embodiment, a digital TV 106a displays the secondary/synced content (e.g., a trivia question), and the user provides an input based on the secondary/synced content (e.g., an answer to the trivia question). In another embodiment, a user can be using, e.g., a smartphone or tablet which displays the secondary/synced content, and the user input is also provided on that same smartphone or tablet.

At step 1106, the user input is transmitted to the blockchain-based server apparatus.

At step 1108, a response is received from the blockchain-based server apparatus.

At step 1110, a determination is made as to whether the response indicates that a contract (e.g., smart contract) is triggered.

If the response does indicate that the contract is triggered, a digital wallet associated with the user is updated for step 1112. For example, digital currency can be deposited in a prescribed secure element or “wallet” function. Optionally, the user can be notified of the update to the digital wallet per step 1114.

Alternatively, if the response does not indicate that the contract is triggered or affirmatively indicates that the contract is not triggered, then either (i) the process can end, or (ii) the process can start back over at step 1102 and/or step 1104—i.e., the secondary/synced content can displayed (e.g.,. the same trivia question or different question can be prompted) or user is notified (per step 1114), and/or the user can provide another input (e.g., another answer).

Referring now to FIG. 11A, one exemplary implementation of the method for a blockchain layer interaction in accordance with the present disclosure is provided.

At step 1122 of the method 1120, the blockchain-based server apparatus receives user input (e.g., data representative of an answer to a trivia question). In one embodiment, the user input is received via the computer program application 204 disposed at least in part on the client device 106 (e.g., digital TV, PC, tablet, smartphone, etc.).

At step 1124, the user input is hashed—i.e., a cryptographic hash of the data representative of the user input. In one embodiment, the hash can be generated using a prescribed hash algorithm of a digital currency. For example, Ethash is a proof-of-work hash function that is used for digital currency currently known in the art as Ethereum; however, Ethereum is planned to move to a proof-of-stake scheme. The present disclosure contemplates use of any “proof-of” schemes known in the art.

Per step 1126, the hashed user input can (optionally) be used to form blocks and chains (i.e., blockchain-based). At its basic level, this means the cryptographic hash of the user input can be joined by other cryptographic hashes to form a hash tree (or Merkle tree). With respect to blockchain technology, a record (block) can be generated for the cryptographic hash and linked to other blocks as part of a chain. Each new block generated utilizes the cryptographic hash of the previous block, and the once a block is recorded into the chain, it cannot be altered. Accordingly, blockchain-based operation allow for an open, distributed ledger that is inherently verifiable—i.e., the records must be valid to be recorded into the ledger.

Per step 1128, the cryptographic hash of the user input, or record based thereon, is transmitted to a validation entity (e.g., one or more validation ledgers 216 or Oracles). Oracles cause external data to be applied to the rules of a smart contract. Various external data can be utilized in accordance with the present disclosure, including, e.g., demographics/psychographic data, geographic data, user profile data, data relating to viewers of channels, participants, buyer/sellers, etc. The smart contract applies rules to the record (e.g., hashed user input that has been recorded in a blockchain) and external data, which when validated, trigger smart contracts. The blockchain provides inherent validation of the records, but the validation entity provide another layer of validation using external data. In some embodiments, the validation entity may correlate or “map” such information (i.e., the external data and the record or blockchain). For example, the validation entity could show how a given prospective advertiser's products and/or services may correlate or “map onto” such information (the record and/or at least a portion of the blockchain). If the rules of the smart contract (i.e., the conditions of the transaction) are met using the such information—e.g., for prospective advertiser's products and/or services demographics fit into that of a user's demographic, based on the record validated in the blockchain—then the smart contract triggers an event, such as a issuing one or more reward(s). Rewards can include, e.g., products/services or monetary payments, including virtual currency which may be automatically deposited into a digital wallet or bank account.

Per steps 1130 and 1132, respectively, the blockchain server apparatus 214 receives the response from the validation entity response is transmitted, transmitting a response to the application program 204.

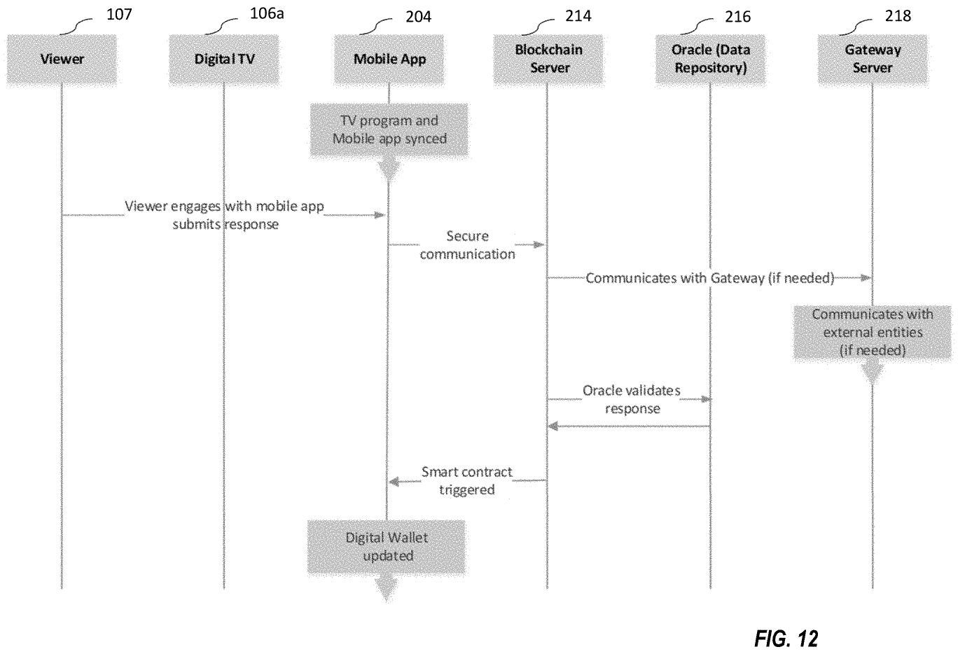

FIG. 12 is a ladder diagram illustrating signal flow between entities for one embodiment of the foregoing methodology.

### Sync Server Apparatus

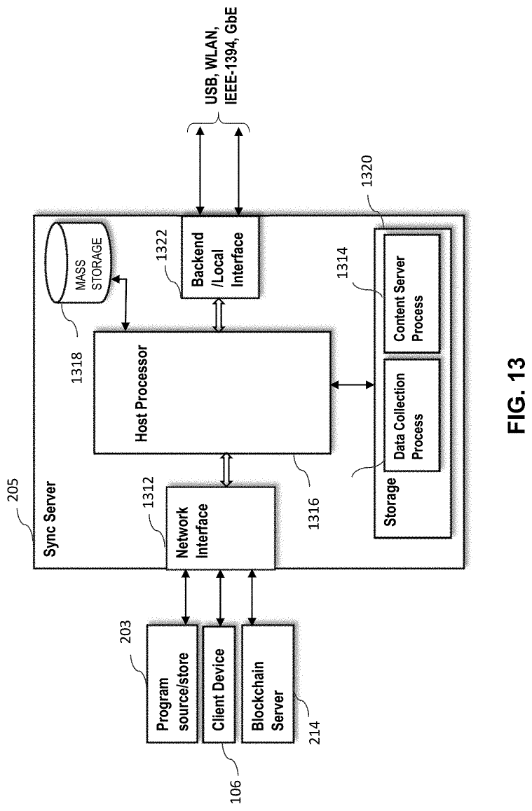

FIG. 13 is an exemplary embodiment of the server apparatus 205 of the type used in the architectures of FIGS. 2 and 2A. The sync server apparatus 205 includes a network interface 1312, which receives the primary content, secondary content, and/or the synced content, as well as any data associated therewith (e.g., advertising data or metadata or other descriptive data), from the content source (e.g., program source, advertiser, etc.) 203 or the origin server 201. The server apparatus is also configured to receive requests from the client device 106, and forward these requests to a processor 1316. The requests may be received through the primary network interface(s) 1312 (e.g., high bandwidth PCIe or similar type of fabric interface), or through one or more of a plurality of backend or local interfaces 1322 such as e.g., USB, IEEE-1394 (Fire Wire), Thunderbolt, IEEE Std. 802.11 (Wi-Fi), GbE, etc. Moreover, the various interfaces 1312, 1322 may be integrated with one another to varying degrees based on the intended application of the sync server 205.

The processor 1316 is configured to communicate with a mass storage device 1318 and memory 1320, where the memory comprises at least one computer program executable on the processor 1316. The computer program comprises a plurality of instructions which are configured to, when executed, receive data relating to the event, and based on such data, cause an event (e.g., smart contract trigger event or synced content display event) at the client device 106. For example, the event may be a display of synced content, or a switch to synced content which is caused by the synced content transmitted from a content server process 1314 to the client device(s) 106. In one variant, network services are sent “over the top” of other provider's infrastructure (whether wireline or wireless or both), thereby making the service network substantially network-agnostic. That is, content server 1314 may be configured to cause delivery of Internet data and OTT (over-the-top) services to the end users via the Internet protocol (IP) and TCP (e.g., over a 5G radio bearer or other interposed infrastructure of the MSO or a participating MNO (mobile network operator)), although other protocols and transport mechanisms of the type well known in the digital communication art may be substituted. In another variant, a cooperative approach between providers is utilized, so that features or capabilities present in one provider's network (e.g., authentication of mobile devices, such as via an IEMI or AAA server) can be leveraged by another provider operating in cooperation therewith.

In one embodiment, the server apparatus 205 is configured to obtain one or more records and/or verification data from one or more respective client devices 106. The records may include various information and/or identifiers about the event, or failure thereof. For example, a record may include one or more of the following: (i) network or user-specific policies, (ii) program identification, (iii) channel identification, (iv) client device information such as MAC or IP address, status, etc., (iv) timestamp data, as well as (v) geographic or location information such as IP address or association with a known network node, a zip code, latitude/longitude, GPS coordinates, etc. In one variant, the server 205 causes the client device 106 to generate the blockchain-based record (for example, based on the occurrence or failure of the event, or based on the verification of the occurrence (or failure) of the event), such as via a GET request, call to an API operative on the client, or other mechanism. The verification data may include textual, audio, or visual verification of the occurrence of the event. In one variant, the server 205 causes the verification of the event; e.g., automatically, such as by utilizing machine learning or AI processes (including one resident as a cloud process and accessed over the data interface(s)) to identify a scenario where verification is required and based thereon, initiate the verification. In an alternative implementation, an operator of the server apparatus 205 may cause the verification, such as by causing a signal or command to the client device(s) 106 via the network interface 1312.

The server apparatus 205 collects/aggregates the records and verification data received from the client device(s), and transmits the composite data to the blockchain server 214, the latter now described in greater detail.

### Blockchain-Based Server—

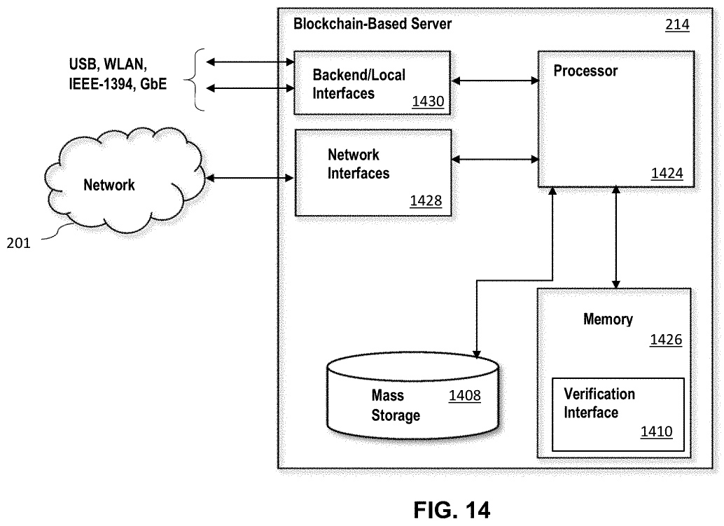

FIG. 14 illustrates one exemplary embodiment of a blockchain-based server apparatus 214 useful with the present disclosure. As shown, the blockchain-based server 214 generally comprises one or more network interfaces 1428 for interfacing with other entities of the content delivery network and/or the managed network headend, a processor 1424, a memory apparatus 1426, mass storage 1408 (e.g., RAID array, solid state drive (SSD), HDD, and/or NAND/NOR flash memory), and may include a plurality of backend or local interfaces 1430 such as e.g., USB, IEEE-1394 (Fire Wire), Thunderbolt, IEEE Std. 802.11 (Wi-Fi), GbE, etc.

In one embodiment, the blockchain-based server apparatus 214 includes one or more computer programs with a plurality of instructions which when executed by the processor 1424, cause the blockchain-based server apparatus 214 to receive the user response or input data from the server apparatus 205, process the user response or input data to generate one or more blocks, and utilize the one or more blocks to form a blockchain. More specifically, the processing includes automatically performing at least one cryptographic hash function (e.g., SHA-256) on one or more record(s) and/or verification data to generate hashes thereof. The records may be in a structured format (such as JavaScript object notation (JSON), which is a lightweight data-interchange format), so that the calculated hash is unique on a per—record basis. As described in greater detail elsewhere herein, a root hash of an inverted tree structure (e.g., Merkle tree) is then computed using those hashes (of the record(s) and/or verification data) and intermediary hashes. The root hash of the current block is then hashed together with the root hash of a previous block, thereby generating a block hash. The linking of the root hash with the root hash of a previous block constitutes the “chain” of the blockchain. Accordingly, the blockchain itself is tasked with validating the events via the automated cryptographic hashing in a hierarchical manner. The validation includes validating the integrity of the data, such that no event is reported twice.

In one embodiment, the hashes may be generated using memory 1426 of the blockchain-based apparatus 214. For instance, the blockchain-based server apparatus 214 may perform a search function on memory 1426 to generate an output (e.g., proof-of-work or proof of stake). Additionally, the blockchain-based server apparatus 214 may store processed data (intermediary (e.g., hashes) or final form (e.g., blockchain ledger)) in memory or a mass storage device 1408, or alternatively in attached local storage or even cloud storage (which may include both MSO and non-MSO network storage).

In one implementation, the application computer program is rendered in a C# (“C Sharp”) object-oriented programming language (C# is used in the exemplary embodiment for use of the .NET Framework, which advantageously provides large libraries with built-in capabilities and methods useful in the context of the present disclosure), although it will be appreciated that other languages may be used consistent with the present disclosure.

The blockchain-based server 214 also includes a verification interface 1410, which is useful for enabling access to various data, such as the hashes of the records and/or verification data, the blockchain ledger, schedule data, reports, etc. In one embodiment, the verification interface 1410 is based on public/private key encryption (PKE), although other approaches may be used. Moreover, it is appreciated that the verification interface 1410 may also include a remote interface (such as via a web-based client application) for the program source/advertiser 203, by which the program source/advertiser 203 can log in to a secure MSO server, review the various data (e.g., blockchain ledger, hashes), provide input as to desired performance, markets, types of good/services, budget, provide payment source information, and other information. For instance, an API may be utilized wherein “calls” to the API via remote device will cause the server apparatus to return the requested data.

Moreover, in one embodiment, the blockchain-based process (i.e., computerized logic rendered as code) is implemented on one or more servers (which may be geographically localized, such as in a server “farm”, or alternatively distributed across multiple geographic regions), and may also be physically and/or logically integrated with other components of the MSO network, such as “oracles,” client devices, etc.

Comparison with Other Blockchains

Blockchain architecture varies by implementation and it is hard to define a standard model. For example, once the 2nd largest cryptocurrency, Ripple is devoid of the salient “distributed ledger” feature of blockchain. Oracle and Smart Contract concepts were introduced by Ethereum and were not part of original Bitcoin protocol. Also, unlike Bitcoin, most private blockchains do not have group consensus mechanism (mining). And some even advocate centralized control. Table 2 illustrates this difference by comparing primary features of our solution against other prominent blockchains.

TABLE 2
FEATURE COMPARISON WITH
OTHER BLOCKCHAINS

| | Other | Our | |
|---|---|---|---|
| Feature | Blockchains | Solution | Comments |
| Blockchain | Mostly | Private | e.g. Ethereum, |
| type | Public | | Bitcoin |
| Cryptographic | Y | Y | |
| hashing | | | |
| Transactions | Buying/ | Payments | |
| | Selling | | |
| Block Mining | Y | N/A | (see comment |
| | | | below) |
| Smart contracts | Y | Y | |
| Block formation | Y | N | |
| Consensus | Byzantine | N/A | (see comment |
| Mechanism | Fault | | below) |
| | Tolerance | | |

In one exemplary embodiment, the blockchain of the present disclosure is a private blockchain with full control by the network administrator, the concept of “data mining” (or the usage of ‘Nonce’ to adjust the difficulty), is not relevant. Technically it falls under POS (proof-of-stake), with one party (Network Operator) governing the decision-making process. Any manifestation of Byzantine faults will be resolved by the network Administrator.

Forming blocks and creating the chain are optional for the proposed architecture, and can be utilized for record keeping purposes.

It will be recognized that while certain aspects of the disclosure are described in terms of a specific sequence of steps of a method, these descriptions are only illustrative of the broader methods of the disclosure, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the disclosure disclosed and claimed herein.

While the above detailed description has shown, described, and pointed out novel features of the disclosure as applied to various embodiments, it will be understood that various omissions, substitutions, and changes in the form and details of the device or process illustrated may be made by those skilled in the art without departing from the disclosure. This description is in no way meant to be limiting, but rather should be taken as illustrative of the general principles of the disclosure. The scope of the disclosure should be determined with reference to the claims.

It will be further appreciated that while certain steps and aspects of the various methods and apparatus described herein may be performed by a human being, the disclosed aspects and individual methods and apparatus are generally computerized/computer-implemented. Computerized apparatus and methods are necessary to fully implement these aspects for any number of reasons including, without limitation, commercial viability, practicality, and even feasibility (i.e., certain steps/processes simply cannot be performed by a human being in any viable fashion).

What is claimed is:

1. A computerized network server apparatus configured to provide synchronized content to one or more users of a content delivery network, said computerized network server apparatus comprising:
a storage entity;
at least one network interface; and
a digital processor apparatus in data communication with the storage entity and the at least one network interface, the digital processor apparatus configured to run at least one computer program thereon, said computer program comprising a plurality of instructions which are configured to, when executed:
receive data representative of a request to perform a synchronization operation, at least a portion of the data generated via a computer application executed on a computerized mobile device;
based at least on the received data, perform the synchronization operation, the synchronization operation configured to identify synchronization data; and
provide at least a portion of the identified synchronization data to the computerized mobile device, the synchronization data configured to enable the computerized mobile device to access the synchronized content via the computer application executed on the computerized mobile device.

2. The computerized network server apparatus of claim 1, wherein the synchronization data comprises metadata indicative of a digital content then-currently displayed on a computerized client device associated with a user of the computerized mobile device.

3. The computerized network server apparatus of claim 2, wherein the synchronization operation comprises:
transmission of data representative of a request for the synchronization data to a manifest manipulator (MM) apparatus, the data representative of the request for the synchronization data configured to cause the MM apparatus to (i) retrieve metadata relating to the digital content then-currently displayed on the computerized client device from an origin server apparatus, and (ii) process the metadata from the origin server apparatus to generate the synchronization data; and
receipt of the synchronization data from the MM apparatus.

4. The computerized network server apparatus of claim 3, wherein the computerized mobile device comprises a smartphone, and the computerized client device comprises a television.

5. The computerized network server apparatus of claim 1, wherein the plurality of instructions are further configured to, when executed:
receive, via the computer application executed on the computerized mobile device, user input relating to the synchronized content; and
transmit the user input relating to the synchronized content to a blockchain-based validation entity, the blockchain-based validation entity configured to validate the user input.

6. The computerized network server apparatus of claim 5, wherein:
a validation of the user input by the blockchain-based validation entity is configured to trigger a smart contract;
the triggered smart contract is configured to cause the computerized network server apparatus to update a digital wallet apparatus associated with the user.

7. A computerized method of providing enhanced user interactivity between computerized client devices, the computerized method comprising:
causing delivery of first digital content via a first transport mechanism to a first computerized client device;
receiving, from a second computerized client device, data representative of a request for second digital content, the second digital content relating to the first digital content;
based at least on the data representative of the request for the second digital content, causing transmission of metadata to the second computerized client device, the metadata configured to enable the second computerized client device to access the second digital content via a second transport mechanism, wherein the second digital content is configured to prompt the second computerized client device for user input;
receiving data representative of the user input;
determining whether the user input is valid using at least one computerized blockchain-based entity; and
based on the determining indicating that the user input is valid, causing execution of an event.

8. The method of claim 7, wherein:
the causing delivery of first digital content via a first transport mechanism to a first computerized client device comprises using a transport mechanism of a managed content delivery network operated by a first network operator, the transport mechanism having a prescribed QoS (quality of service) level associated therewith; and
the receiving, from a second computerized client device, data representative of a request for second digital content, the second digital content relating to the first digital content comprises receiving the data representative of the request via at least a wireless network infrastructure managed by a second network operator.

9. The method of claim 7, wherein the determining whether the user input is valid using at least one computerized blockchain-based entity comprises using a proof-of mechanism.

10. The method of claim 9, wherein the receiving data representative of the user input comprises receiving data that has been anonymized via use of an identifier such that a user of at least one of the first computerized client device or second computerized client device cannot be identified.

11. A network architecture configured to enable both preservation of user privacy and validation of proposed rewards as part of interaction with third-party content delivered via the network architecture, comprising:
a first content delivery mechanism configured to deliver primary content to at least one user device of the network architecture;
a second content delivery mechanism configured to deliver secondary content to the at least one user device of the network architecture; and
server apparatus in data communication with the first content delivery mechanism and second content delivery mechanism, the server apparatus configured to utilize a private distributed ledger process to enable both (i) preservation of anonymity for an input provided by the user of the network architecture; and (ii) payment of a reward to an account of the user.

12. The network architecture of claim 11, wherein:
the first content delivery mechanism comprises a downstream RF (radio frequency) channel in a first managed service provider network; and
the second content delivery mechanism comprises a downstream RF (radio frequency) channel in a second managed service provider network.

13. The network architecture of claim 12, wherein at least a portion of the managed service provider network comprises a virtual-multichannel video programming distributor (vMVPD) network.

14. The network architecture of claim 11, wherein the server apparatus comprises a blockchain process configured to at least (i) generate an anonymized user ID value associated with the at least one user device; and (ii) cause credit of the reward to a digital wallet account of the user.

15. The network architecture of claim 11, wherein the at least one user device comprises first and second user devices, the second user device comprising a mobile device with application computer program configured to execute thereon, the application computer program configured to communicate with the server apparatus for the (i) preservation of anonymity; and (ii) payment of a reward to an account of the user.
